(19) United States
(12) Patent Application Publication
(10) Pub. No.: US 2006/0109343 A1
(43) Pub. Date: May 25, 2006

(54) Image displaying system, image providing apparatus, image displaying apparatus, and computer readable recording medium

(76) Inventors: Kiyoaki Watanabe, Tokyo (JP); Yohko Kawai, Tokyo (JP); Takayuki Mitsuhashi, Kanagawa (JP); Youichi Sumida, Hyogo (JP); Takuma Watanabe, Hyogo (JP)

Correspondence Address: BRINKS HOFER GILSON & LIONE, P.O. BOX 10395, CHICAGO, IL, 60610, US

(21) Appl. No.: 11/192,730

(22) Filed: Jul. 29, 2005

(30) Foreign Application Priority Data
Jul. 30, 2004 (JP) 2004-223937

(51) Int. Cl. H04N 7/18; G02B 21/36

(52) U.S. Cl. 348/79; 359/369

(57) ABSTRACT

An image displaying system is described that includes (a) an image providing apparatus comprising a first transmitting means for transmitting a first image of a cell, and a second transmitting means for transmitting a second image of a higher resolution than the first image of the cell shown in the first image; and (b) an image displaying apparatus comprising an image display unit, a first receiving means for receiving the first image transmitted from the image providing apparatus, a second receiving means for receiving the second image transmitted from the image providing apparatus, a first display means for displaying the first image in a first region of the image display unit, and a second display means for displaying the second image in a second region of the image display unit, wherein the second transmitting means transmits partial images required for display by the second display means on a priority basis relative to the other partial images among a plurality of partial images of the segmented second image, and the second receiving means receives the partial images transmitted from the image providing apparatus while previously received partial images are displayed on the second display means. An image providing apparatus, an image displaying apparatus, and a computer readable recording medium are also described.

This application claims priority under 35 U.S.C. §119 to Japanese Patent Application No. 2004-223937, filed Jul. 30, 2004, the entire content of which is hereby incorporated by reference.

### FIELD OF THE INVENTION

The present invention relates to an image displaying system for displaying captured images of cells, image providing apparatus having the image displaying system, and image displaying apparatus, and recording medium for storing computer programs to provide computer functions as the image displaying apparatus.

### BACKGROUND

In conventional examinations of blood cells, the method in which a smear sample is prepared using a target blood specimen deposited on a preparate and visually examined under a microscope is called microscopic examination. In microscopic examination, for example, as the smear sample is viewed under the microscope, a classification count is performed for the white blood cells present in a certain region of the smear sample using a special classification counter provided with a keyboard which allocates blood cell classification items for each key. Furthermore, when red blood cells, platelets with abnormal morphology, and cells which are difficult to classify (white blood cells) are found during the classification counting operation, imaging of these cells is accomplished using a video camera attached to the microscope. Then, the image of the captured blood cells is filed (saved) in an image filing system database together with attribute information (clinical chart number and the like) of the examination subject. After the examination is completed, the classification count result is printed, and the filed blood cell image is printed as necessary to create the examination results.

In the aforesaid method, however, the examiner must perform the examination at the place at which the microscope is installed in order to visually examine the smear sample under the microscope. Therefore, the examiner is inconvenienced by the restricted location.

In the aforesaid microscopic examination, moreover, a dry objective lens having a low/intermediate magnification ratio, and an oil immersion objective lens having a high magnification ratio are generally used together. In this case, the examiner performs a classification count in a relatively large range within the smear sample using the low/intermediate magnification ratio dry objective lens, and uses the high magnification oil immersion objective lens to confirm morphological details of cells for which morphological confirmation is difficult using the low/intermediate magnification dry objective lens.

Since the smear sample must be adhered with oil in order to confirm the morphology of the target cell using the oil immersion objective lens, the dry objective lens cannot be used thereafter until the oil has been washed from the smear sample. Since considerable time and labor are required to exchange the oil immersion objective and the dry objective lenses, frequent lens exchanges to improve the accuracy of the examination are problematic.

Conventional art has also been proposed for imaging a pathological cell diagnostic sample using a microscope to prepare a virtual microscope slide (sample image) (for example, refer to international patent application publication No. WO98/39728). According to this art, since the virtual microscope slide (sample image) can be electronically transmitted over the internet, the virtual microscope slide (sample image) can be downloaded to a computer on which is installed a predetermined program, such that the virtual microscope slide can then be examined. Accordingly, if the art disclosed in Patent Document 1 is used, the examiner need not perform the examination at the location at which the microscope is installed, such that the examination may be performed using the virtual microscope slide (sample image) without restriction of location.

Japanese National Phase Laid-Open Patent Publication No. 2002-514319 further discloses art for displaying a low resolution macro view (low resolution image) of the entire sample image, and displaying a high resolution micro view (high resolution image) of a specific image tile. In this way the examiner can confirm a relatively large range of the virtual microscope slide in the macro view, and use the micro view to confirm the detailed morphology of cells for which morphological confirmation is difficult in the macro view, without the labor of exchanging the lenses.

This type of virtual microscope slide requires the examination of individual cells which are large enough to allow confirmation of the morphology of the cell, and requires imaging even of a small range as an examination target within the sample in order for the examiner to examine the cells. To satisfy these requirements, the virtual microscope slide must contain a large amount of data which are transmitted over the internet to be used by the examiner, and the downloading of the data to the client computer of the examiner necessarily takes considerable time. Accordingly, the method disclosed in Patent Document 1 is exceptionally inconvenient inasmuch as examination cannot be performed until the downloading of the virtual microscope slide has been completed since the virtual microscope slide is only displayed after the entire virtual microscope image has been completely downloaded to the client computer.

### SUMMARY

The scope of the present invention is defined solely by the appended claims, and is not affected to any degree by the statements within this summary.

An image displaying system embodying features of the present invention includes (a) an image providing apparatus provided with a first transmitting means for transmitting a first image of a cell, and a second transmitting means for transmitting a second image of a higher resolution than the first image of the cell shown in the first image; and (b) an image displaying apparatus provided with an image display unit, a first receiving means for receiving the first image transmitted from the image providing apparatus, a second receiving means for receiving the second image transmitted from the image providing apparatus, a first display means for displaying the first image in a first region of the image display unit, and a second display means for displaying the second image in a second region of the image display unit, wherein the second transmitting means transmits partial images required for display by the second display means on a priority basis relative to the other partial images among a plurality of partial images of the segmented second image, and the second receiving means receives the partial images transmitted from the image providing apparatus while previously received partial images are displayed on the second display means.

An image providing apparatus embodying features of the present invention includes (a) a first transmitting means for transmitting a first image of a cell; and (b) a second transmitting means for transmitting a second image of a higher resolution than the first image of the cell shown in the first image, wherein the second transmitting means transmits the partial images required for display on an external device among a plurality of partial images of the segmented second image.

An image displaying apparatus embodying features of the present invention includes (a) an image display unit; (b) a first receiving means for receiving a first image showing cells from an external device; (c) a second receiving means for receiving from an external device a second image of a higher resolution than the first image of the cell shown in the first image; (d) a first display means for displaying the first image in a first region of the image display unit; and (e) a second display means for displaying the second image in a second region of the image display unit, wherein the second receiving means receives other partial images from an external device while the second display means displays previously received partial images among a plurality of partial images of the segmented second image.

A computer readable recording medium embodying features of the present invention is for recording computer programs executed by a computer, wherein the computer program provides the computer with the functionality of (a) a first receiving means for receiving a first image showing cells from an external device; (b) a second receiving means for receiving from an external device a second image of a higher resolution than the first image of the cell shown in the first image; (c) a first display means for displaying the first image received by the first receiving means in a first region of the image display unit; and (d) a second display means for displaying part of the second image received by the second receiving means in a second region of the image display unit, wherein the second receiving means receives other partial images from an external device while the second display means displays previously received partial images among a plurality of partial images of the segmented second image.

### BRIEF DESCRIPTION OF THE DRAWINGS

FIG. 1 is a schematic view showing the structure of the image display system of a first embodiment of the present invention.

FIG. 2 is a block diagram showing the structure of the computer of the first embodiment of the present invention.

FIG. 3 is a block diagram showing the structure of the image providing apparatus of the first embodiment of the present invention.

FIG. 4 is a flow chart showing the sequence of the virtual slide recording operation by the image display system of the first embodiment of the present invention.

FIG. 5 is a conceptual illustration describing the method of creating a virtual slide (blood cell image) in the first embodiment of the present invention.

FIG. 6 is a flow chart showing the sequence of the virtual slide creation process in the first embodiment of the present invention.

FIG. 7 is a conceptual drawing illustrating the virtual slide division and management method in the first embodiment of the present invention.

FIG. 8 is a flow chart showing the sequence of the virtual slide division process in the first embodiment of the present invention.

FIG. 9 is a flow chart showing the sequence of the classification count operation of the image display system of the first embodiment of the present invention.

FIG. 10 is a flow chart showing the sequence of the classification count operation of the image display system of the first embodiment of the present invention.

FIG. 11 is a flow chart showing the sequence of the classification count operation of the image display system of the first embodiment of the present invention.

FIG. 12 is a flow chart showing the sequence of the classification count operation of the image display system of the first embodiment of the present invention.

FIG. 13 is a flow chart showing the sequence of the classification count operation of the image display system of the first embodiment of the present invention.

FIG. 14 shows an example of a screen display of the computer 2 in the white blood cell classification count operation by the image display system of the first embodiment of the present invention.

FIG. 15 shows an example of a screen display of the computer 2 in the white blood cell classification count operation by the image display system of the first embodiment of the present invention.

FIG. 16 is a schematic view illustrating the transmission order of the low resolution images in the first embodiment of the present invention.

FIG. 17 is a flow chart showing part of the sequence of the classification count operation of the image display system of a second embodiment of the present invention.

FIG. 18 shows an example of a screen display of the computer 2 in the white blood cell classification count operation by the image display system of the second embodiment of the present invention.

FIG. 19 is a flow chart showing part of the sequence of the classification count operation of the image display system of a third embodiment of the present invention.

FIG. 20 is a flow chart showing part of the sequence of the classification count operation of the image display system of the third embodiment of the present invention.

FIG. 21 shows an example of a screen display of the computer 2 in the white blood cell classification count operation by the image display system of the third embodiment of the present invention.

FIG. 22 illustrates the white blood cell classification count items in the third embodiment of the present invention.

FIG. 23 is an enlargement of the first window shown in FIG. 21.

### DETAILED DESCRIPTION OF THE DRAWINGS AND THE PRESENTLY PREFERRED EMBODIMENTS

The image displaying system, image providing apparatus, image displaying apparatus, and computer program of the embodiments of the present invention are described in detail hereinafter with reference to the drawings. They are provided solely by way of illustration, and not intended to limit the scope of the appended claims or their equivalents.

### First Embodiment

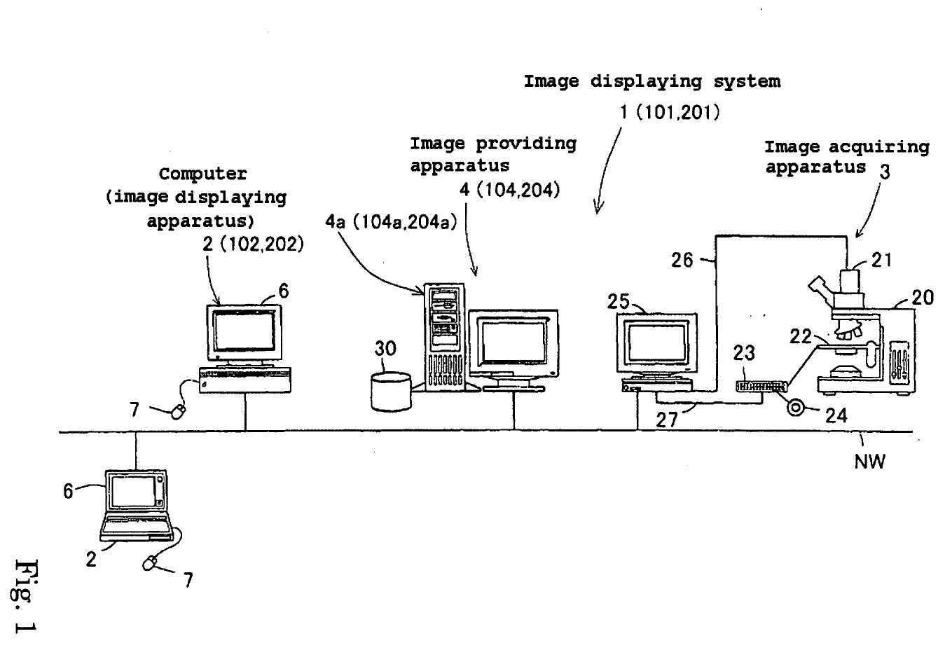

FIG. 1 is a schematic view showing the structure of the image display system of a first embodiment of the present invention. As shown in FIG. 1, an image displaying system 1 is mainly configured by a computer 2 which functions as an image displaying apparatus, image acquiring apparatus 3, and an image providing apparatus 4. The image acquiring apparatus 3 and image providing apparatus 4 are, for example, provided within a medical facility, such as a hospital or pathology laboratory, and the computer 2, image acquiring apparatus 3, and image providing apparatus 4 are connected over a communication network such as the internet or LAN so as to be capable of mutual data communication.

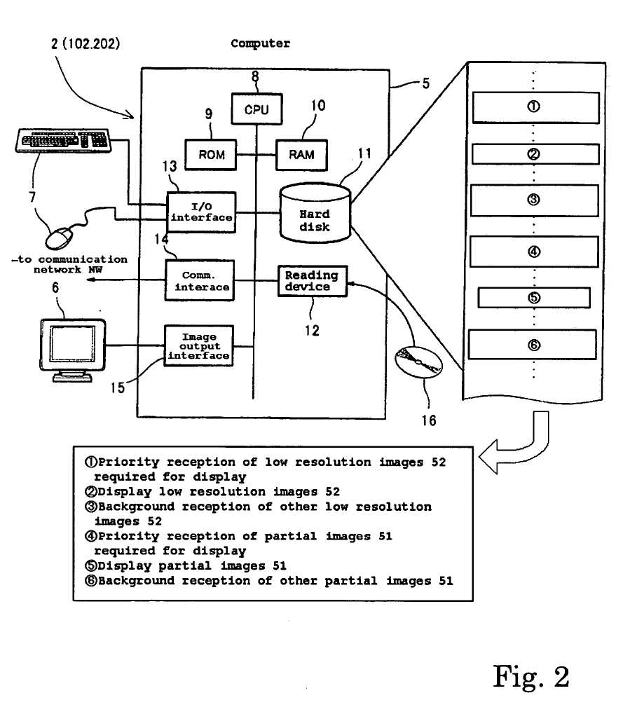

FIG. 2 is a block diagram showing the structure of the computer 2. The computer 2 is mainly configured by a body 5, image display unit 6, and input unit 7. The body 5 is mainly configured by a CPU 8, ROM 9, RAM 10, hard disk 11, reading device 12, I/O interface 13, communication interface 14, and image output interface 15.

The CPU 8 is capable of executing computer programs stored in the ROM 9, and computer programs loaded in the RAM 10. The computer 2 functions as an image displaying device when the computer program is executed by the CPU 8 in the first embodiment as described later. The ROM 9 may be a mask ROM, PROM, EPROM, EEPROM or the like, which stores a computer program executed by the CPU 8, and data and the like used by the computer program. The RAM 10 may be an SRAM, DRAM or the like. The RAM 10 is used when reading the computer programs recorded in the ROM 9 and hard disk 11. When these computer programs are executed, the RAM 10 is used as the work area of the CPU 8.

The hard disk 11 contains the installed operating system, application programs and the like, and the various computer programs and data used in the execution of the computer programs executed by the CPU 8.

The reading device 12 is configured by a floppy disk drive CD-ROM drive, or DVD-ROM drive or the like, and is capable of reading the computer programs or data stored on a portable storage medium 16. Furthermore, the computer 2 is capable of reading the computer programs of the present embodiment from the portable storage medium 16, and installing the computer programs on the hard disk 11.

The computer programs of the first embodiment need not necessarily be provided on the portable storage medium 16, and may be provided over an electrical communication line from a communication-capable device connected to the computer 2 by the electrical communication line (wire line or wireless). For example, the computer programs of the present invention may be stored beforehand on the hard disk of a server computer over the internet, such that the computer 2 may access the server computer to download the computer programs, and install the computer programs on the hard disk 11.

The I/O interface 13 may be, for example, a serial interface such as a USB, IEEE1394, RS-232C or the like, a parallel interface such as SCSI, IDE, IEEE1284 or the like, and an analog interface such as a D/A converter, A/D converter or the like. The I/O interface 13 is connected to an input unit 7 configured by a keyboard and mouse, such that a user (for example, clinical technician or physician) may input data to the computer 2 using the input unit 7. The communication interface 14 may be, for example, an Ethernet (trademark) interface, such that the computer 2 can send and receive data with the image providing apparatus 4 connected to a communication network NW using predetermined communication protocols by means of the communication interface 14. The image output interface 15 is connected to an image display unit 6, such as an LCD, CRT or the like, so as to output image signals corresponding to image data received from the CPU 8 on the image display unit 6. The image display unit 6 displays the images (screens) in accordance with the input image signals.

The structure of the image acquiring apparatus 3 is described below. The image acquiring apparatus 3 creates high resolution images of the blood cells contained in the blood smear sample (hereinafter referred to as “virtual slides”), and is mainly configured by an optical microscope 20 which has 10×, 20×, 40×, and 60× dry objective lenses, and a 100× oil immersion objective lens, a 3CCD camera 21 for acquiring images, automatic microscope stage 22 which is automatically position-adjustable in XYZ directions, control device 23 and joystick 24 for controlling the position of the automatic stage 22, and computer 25 for performing image tiling and focusing together with the position control of the automatic stage 22. In the first embodiment, for example, a BX-50 model series manufactured by Olympus Corporation, may be used as the optical microscope 20, an H101BX model stage manufactured by Prior Scientific Instruments Ltd., may be used as the automatic stage 22, and a KY-F70B model manufactured by Victor Company of Japan Ltd., may be used as the 3CCD camera 21. Furthermore, the computer 25 is connected to the 3CCD camera 21 by an image signal transmission cable 26, and connected to the control device 23 and joystick 24 by control signal transmission cable 27.

Furthermore, the computer 25 is provided with a CPU, ROM, RAM, hard disk and the like (not shown in the drawing), and the hard disk stores the computer programs for accomplishing positioning control of the automatic stage 22, focusing, and image tiling. The computer 25 operates in a manner described later by executing the computer programs. The computer 25 is connected to a communication network NW by means of an internal communication interface (not shown in the drawing), such that the computer 25 is capable of data communication with other devices, such as the image providing apparatus 4 over the communication network NW.

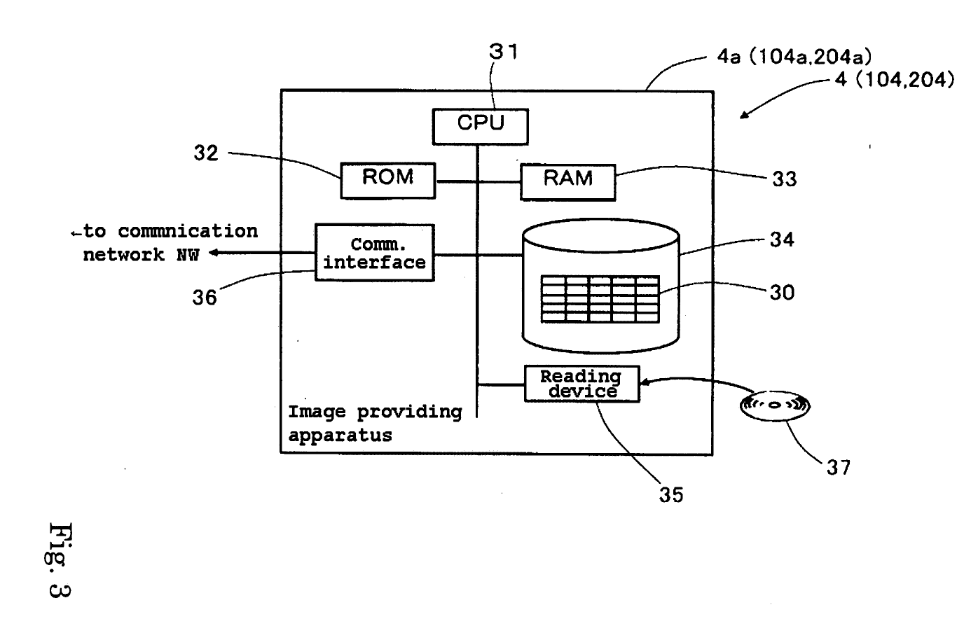

FIG. 3 is a block diagram showing the structure of the image providing apparatus of the first embodiment of the present invention. The image providing apparatus 4 manages virtual slides created by the image acquiring apparatus 3, provides the images to external devices, and performs image division, and is configured by a computer 4a provided with a CPU 31, ROM 32, RAM 33, hard disk 34, reading device 35, and communication interface 36. The CPU 31 is capable of executing computer programs stored in the ROM 32, and computer programs loaded in the RAM 33. The computer 4a functions as an image providing apparatus 4 when the computer programs of the present invention are executed by the CPU 31 in a manner described later. The ROM 32 may be a mask ROM, PROM, EPROM, EEPROM or the like, which stores a computer program executed by the CPU 31, and data and the like used by the computer program. The RAM 33 may be an SRAM, DRAM or the like. The RAM 33 is used when reading the computer program recorded in the ROM 33 and hard disk 34. When these computer programs are executed, the RAM 33 is used as the work area of the CPU 31.

The hard disk 34 contains the installed operating system, application programs and the like, and the various computer programs and data used in the execution of the computer programs executed by the CPU 31. Furthermore, the hard disk 34 is provided with a database 30, which mutually associates and stores mutually associated virtual slide data, classification count result data, and discrimination information such as the sample number.

Classification count result information includes images of the classified cells, position information, classification name, classification date, person doing the classification and the like.

The reading device 35 is configured by a floppy disk drive, CD-ROM drive, or DVD-ROM drive or the like, and is capable of reading the computer programs or data stored on a portable storage medium 37. Furthermore, the portable recording medium 37 stores computer programs for providing a computer with functionality of the image providing apparatus of the present invention, such that the computer 4a reads the computer programs from the portable recording medium 37, and installs these computer programs on the hard disk 34.

The computer programs need not be provided by the portable recording medium 37 inasmuch as these computer programs may also be provided over an electrical communication line from a communication-capable device connected to the computer 4a by the electrical communication line (wire line or wireless). For example, the computer programs of the present invention may be stored beforehand on the hard disk of a server computer over the internet, such that the computer 4a may access the server computer to download the computer programs, and install the computer programs on the hard disk 34.

The communication interface 36 may be, for example, an Ethernet (trademark) interface, such that the computer 4a can send and receive data with the image acquiring apparatus 3 connected to a communication network NW using predetermined communication protocols by means of the communication interface 36.

The operation of the image displaying system 1 of the first embodiment of the present invention is described below. The computer 2 and the computer 4a operate as described below by executing the computer programs respectively stored on the hard disks 11 and 34. In the following description, the computer programs which provide computers with the functionality of the image providing apparatus and image displaying apparatus of the present invention operate under an operating system, such as, for example, Windows (trademark) manufactured by Microsoft corporation or the like.

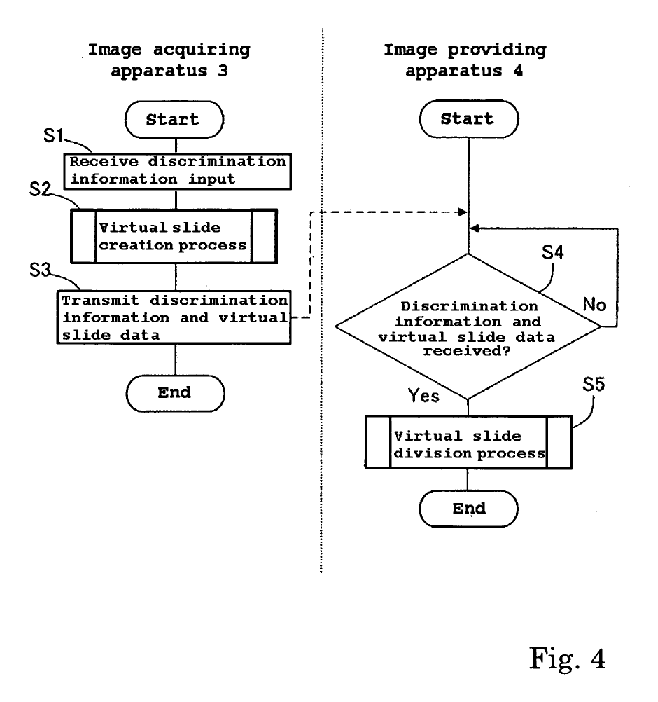

The operation of the image displaying system 1 is divided into a virtual slide recording operation in which virtual slides are created and recorded in the database 30, and a classification count operation for classification of the blood cells in which a user accesses the virtual slides recorded in the database 30. The virtual slide recording operation is described below. FIG. 4 is a flow chart showing the sequence of the virtual slide recording operation by the image display system 1 of the first embodiment of the present invention. As shown in FIG. 4, the image acquiring apparatus 3 first receives input discrimination information (step S1). The operator who creates the virtual slide confirms the discrimination information of the blood smear sample used to create the virtual slide, and inputs the discrimination information to the image acquiring apparatus 3 by operating the input device, such as a keyboard or the like, provided on the computer 25 of the image acquiring apparatus 3. The process of receiving data input as in step S1 in the computer program in the first embodiment of the present invention includes a process for sending and receiving data and a process of displaying the data as described later; these processes are defined as receiving input, sending and receiving data, and displaying images by data input and output to/from the device drivers, and does not include the functions of the respective device drivers which control the input device (input unit) of the operating system, communication interface, and image output interface.

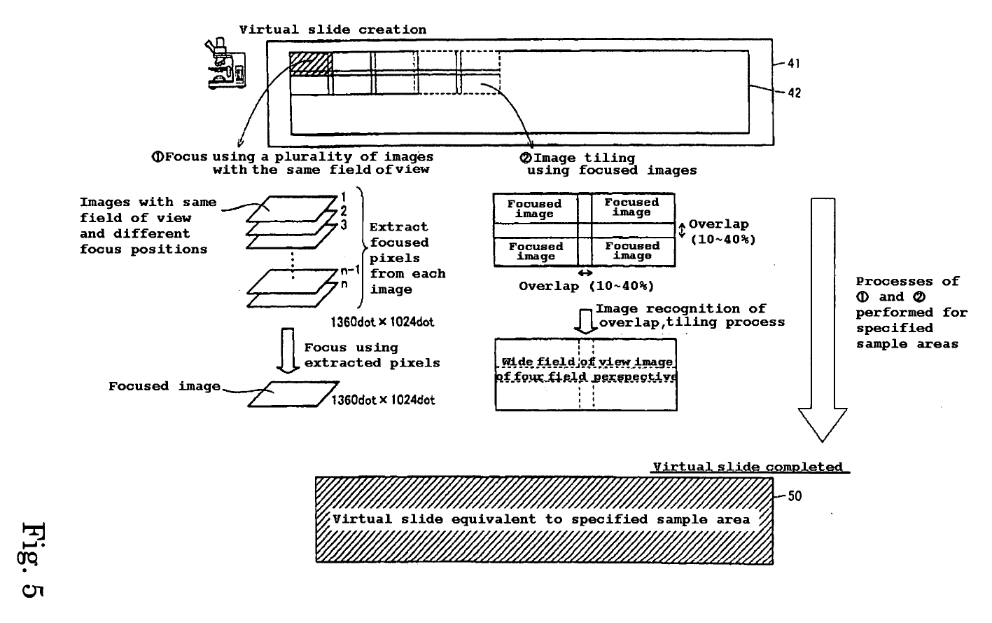

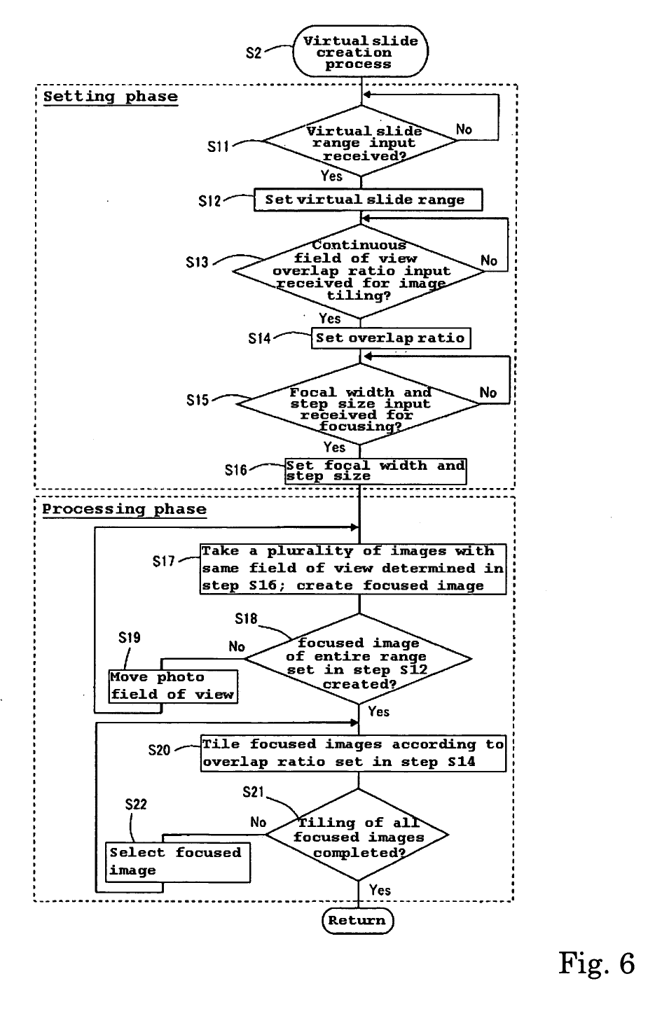

The image acquiring apparatus 3 then executes the virtual slide creating process for creating a virtual slide from the blood smear sample (step S2). FIG. 5 is a conceptual illustration describing the method of creating a virtual slide (blood cell image) in the first embodiment of the present invention, and FIG. 6 is a flow chart showing details of the sequence of the virtual slide acquiring process of step S2. As shown in FIG. 6, the virtual slide acquiring process includes a setting phase and a processing phase. In the setting phase, the operator first places the sample on the optical microscope 20 which is provided with a mounted automatic stage 22. As shown in FIG. 5, a smear sample 42 which is smeared in a specific region on the surface of the sample slide glass 41 may be used as the sample. The computer 25 then determines whether or not virtual slide region input has been received (step S11). The operator uses the input device of the computer 25 to input the virtual slide region (sample area: distance in X and Y directions) to the image acquiring apparatus 3. When the virtual slide range input has been received (FIG. 6, step S11: YES), the computer 25 sets the range of the virtual slide as the input values (step S12). When the virtual slide range input has not been received in step S11 (FIG. 6, step S11: NO), the computer 25 repeats the process of step S11 until input is received. The computer 25 then determines whether or not overlay ratio input has been received to obtain a continuous field of view for image tiling (step S13). (In the present specification, the term “tiling” indicates a process of connecting a plurality of images in a continuous field into a single unified image. This term is used for both the process of connecting each image such that the images are not mutually overlaid, and the process of connecting each image such that a part of the images are mutually overlaid.) The operator uses the input device of the computer 25 to input the overlay ratio to the computer 25. The overlay ratio is preferably set at approximately 10% or more but less than 40%. When the continuous field overlay ratio input has been received (FIG. 6, step S13: YES), the computer 25 sets the continuous field overlay ratio to the input value (step S14). When the continuous field overlay ratio input has not been received in step S13 (FIG. 6, step S13: NO), the computer 25 repeats the process of step S13 until input is received. The computer 25 then determines whether or not the focal width (distance in Z direction) and step size have been input (step S15). The focal width is the difference in the maximum depth and the minimum depth when a plurality of images having different focal depths in the same field of view are captured. The step size is the difference in focal depths of two continuous image captures when the focal depth is sequentially changed in image capture. The operator uses the input device of the computer 25 to input the focal width and step size to the computer 25. The number of images captured from the same field of view can be determined by setting the focal width and step size. In the first embodiment, the focal width is set at less than approximately 1 mm, and the step size is set at approximately 0.1 μm. When the focal width and step size input have been received (FIG. 6, step S15: YES), the computer 25 sets the focal width and step size to the input values (step S16). When the focal width and step size input have not been received in step S15 (FIG. 6, step S15: NO), the computer 25 repeats the process of step S15 until input is received. The setting phase of the virtual slide (blood cell image) acquiring process is completed by the aforesaid steps S11 through S16.

The processing phase is described below. In the processing phase, the plurality of images determined in step S16 for the same field of view are captured by the 3CCD camera 12 and provided to the computer 25 a focused image is created by the computer 25 (step S17). Focusing of the plurality of images having different focus positions in the same field of view is a process in which focused pixels are extracted from each image, and these focused pixels are combined to create a single complete focused image. In the first embodiment, the all images captured in the same field of view are focused to create a focused composite image at a resolution of 1360×1024 dots, as shown in FIG. 5. The format of the focused composite image may be, for example, TIFF format.

The computer 25 then determines whether or not a focused composite image has been created for the entire range set in step S12 (step S18), and when there are residual parts which are not included in the created focused composite image (FIG. 6, step S18: NO), the automatic stage 22 is moved to change the imaging field of view of the 3CCD camera 21 (step S19), then the process returns to step S17 and focused composite images are created at the new field of view.

When it is determined in step S18 that a focused composite image has been created for the entire set range (FIG. 6, step S18: YES), the computer 25 performs image tiling of the focused composite images in accordance with the overlay ratio set in step S14 (step S20). At this time the computer 25 recognizes the overlaid parts of adjacent focused composite images by means of a well known pattern matching process, synthesizes two images by mutually matching the overlaid parts of the respective images such that the seams are not conspicuous. The computer 25 then determines whether or not image tiling has been accomplished for all focused composite images (step S21), and when focused composite images remain for which image tiling has not been performed (FIG. 6, step S21: NO), one of the remaining focused composite images is selected as a processing object (step S22), and the process returns to step S20 and image tiling is performed for this focused composite image as the processing object. When it is determined in step S21 that image tiling has been completed for all focused composite images (FIG. 6, step S21: YES), the virtual slide 50 is completed. The format of the virtual slide image may be, for example, BMP format. The size of the virtual slide 50 created by the previously described processes in the first embodiment is approximately 220,000×134,000 dots.

As shown in FIG. 4, the image acquiring apparatus 3 then transmits the virtual slide 50, which was created in the virtual slide acquiring process, and the discrimination information input in step S1 to the image providing apparatus 4 (step S3). The image providing apparatus 4 determines whether or not the aforesaid data have been received (step S4), and enters reception standby mode in which this process is repeated until the data are received (FIG. 4, step S4: NO). When the discrimination information and virtual slide 50 have been received in step S4 (FIG. 4, step S4: YES), the image providing apparatus 4 executes the virtual slide division process (step S5).

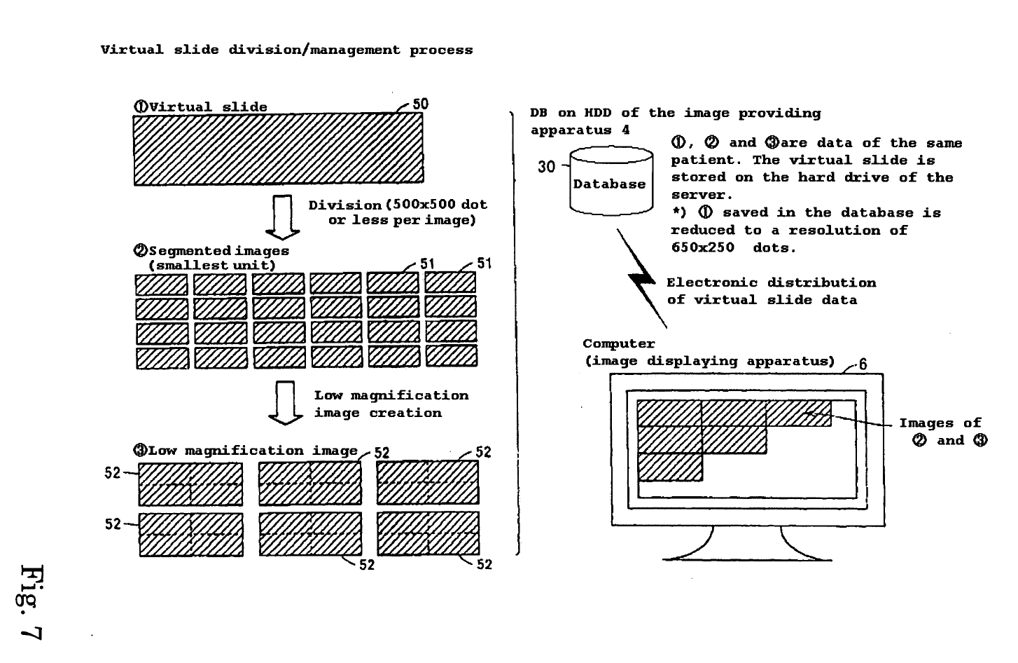

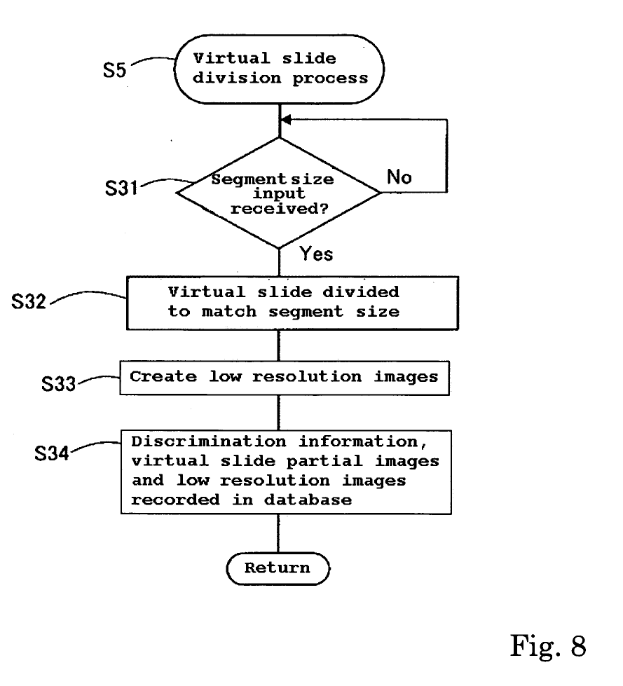

The virtual slide division process is described in detail below. FIG. 7 is a conceptual drawing illustrating the virtual slide division and management methods, and FIG. 8 is a flow chart showing details of the sequence of the virtual slide division process of S5. The image providing apparatus 4 determines whether or not the virtual slide segment size input has been received (step S31). The operator inputs the virtual slide segment size to the image providing apparatus 4 using an input device (not shown in the drawing) provided on the image providing apparatus 4. In the following description, the virtual slide is divided into a plurality of partial images, each partial image is a 500×500 dot segment. It is desirable that the segment size is, for example, 500×500 dots to 1300×1300 dots when the screen resolution of the computer 2 is SXGA (1280×1024 dots). This segment size is comprehensively determined by specifications such as the screen resolution and physical memory capacity of the computer 2, and the communication line speed of the communication network NW. When the virtual slide segment size input has been received in this way (FIG. 8, step S31: YES), the image providing apparatus 4 then divides the virtual slide received in step S4 in accordance with the input segment size (step S32). That is, a plurality of partial images 51 are created from the virtual slide 50 by the process of step S22, as shown in FIG. 7. The format of the partial images 51 may be, for example, JPEG format. When the virtual slide segment size input is not received in step S31 (FIG. 8, step S31: NO), the image providing apparatus 4 repeats the process of step S31 until input has been received.

The image providing apparatus 4 then creates low resolution images 52 (step S33). Specifically, the small file size low resolution images 52 are created by linking a plurality of consecutively aligned partial images 51 (four are shown in FIG. 7) to create a wide field of view image, and reducing the resolution of this wide field of view image, as shown in FIG. 7. For example, low resolution images 52 are created which are equivalent to imaging using a 40× magnification objective lens from partial images 51 of a virtual image 50 created using a 100× magnification objective lens of the optical microscope 20. The format of the low resolution images 52 may be, for example, JPEG format.

The image providing apparatus 4 then records the discrimination information received in step S4, virtual slide 50, partial images 51 created in step S32, and low resolution images 52 created in step S33 in the data base 30 (step S34), and the process ends (return). It is also possible to not directly record the virtual slide 50 in the database 30, and create images by reducing the resolution of the virtual slide 50 to, for example, approximately 650×250 dots and record these images in the database 30. Thus, the virtual slide recording operation ends.

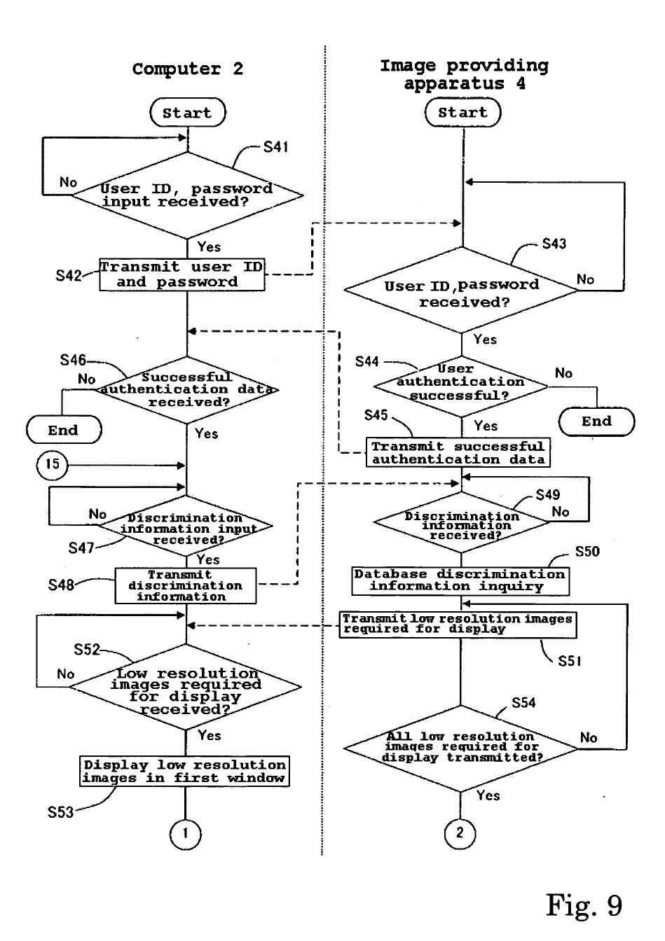

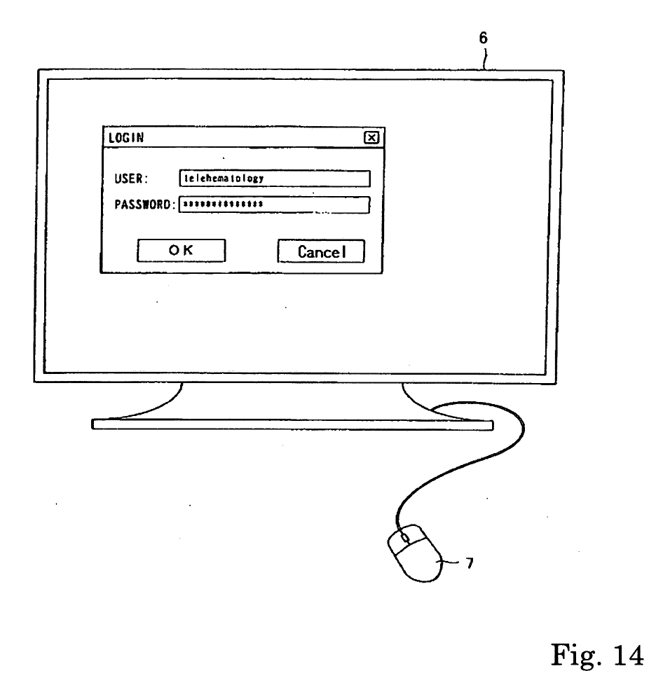

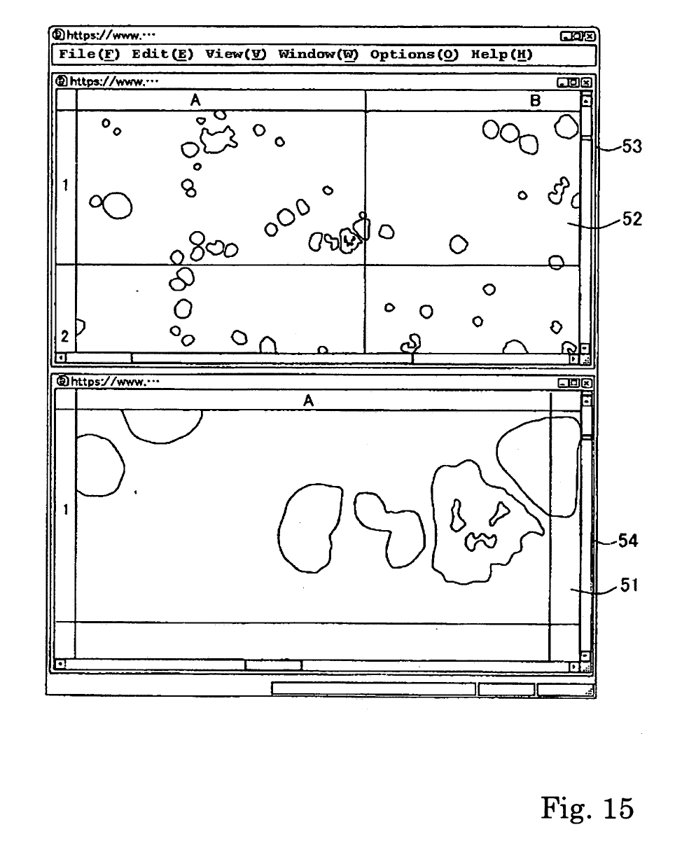

The classification count operation is described below. FIGS. 9 through 13 are flow charts showing the sequence of the classification count operation of the image display system 1 of the first embodiment of the present invention. FIGS. 14 and 15 show examples of screen displays of the computer 2 in the white blood cell classification count operation by the image display system of the first embodiment of the present invention. First, the computer 2 displays the login screen shown in FIG. 14, and determines whether or not the user ID and password required to access the database 30 have been received (step S41), and enters an input standby mode and repeats this process until input has been received (FIG. 9, step S41: NO). The user ID and password are issued beforehand to users of the database 30 by the systems manager who manages the database 30, and are used to authenticate the individual user. The computer 2 displays a login screen which has input boxes for the user ID and the password, as shown in FIG. 14. The user then inputs the user ID and password to the computer 2 by operating the input unit 7 of the computer 2, and clicks the [OK] bottom displayed on the image display unit 6. Thus, the user ID and password are received in step S31 (FIG. 9, step S31: YES). The data are transmitted to the image providing apparatus 4 (step S42). The image providing apparatus 4 determines whether or not the data of the user ID and password have been received (step S43), and enters a reception standby mode and repeats the process until data have been received (FIG. 9, step S43: NO). When the user ID and password have been received in step S43 (FIG. 9, step S43: YES), the image providing apparatus 4 authenticates the individual by well known authentication art (step S44). When there is an authentication failure at this time, the process ends. Furthermore, when authentication is successful in step S44 (FIG. 9, step S44: YES), the image providing apparatus 4 transmits data indicating successful authentication to the computer 2 (step S45). The computer 2 determines whether or not the aforesaid data have been received (step S46), and enters reception standby mode in which this process is repeated until the data are received (FIG. 9, step S46: NO). Furthermore, when the successful authentication data have been received in step S46 (FIG. 9, step S46: YES), the computer 2 completes the login to the database 30.

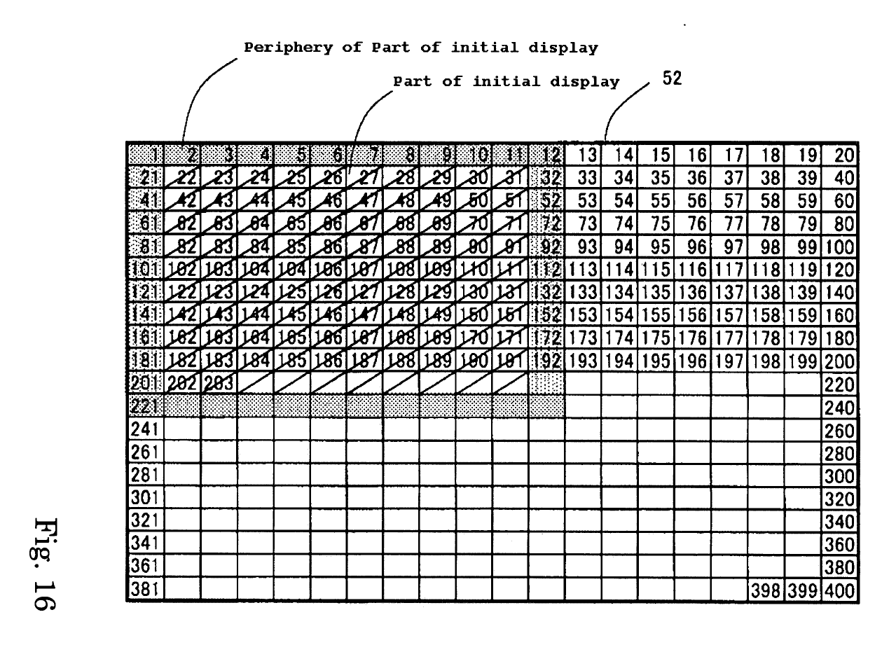

The computer 2 then displays the discrimination information input screen (not shown in the drawing) on the image display unit 6 and receives the discrimination information input (step S47). The user inputs discrimination information corresponding to the examination object in the computer 2 using the input unit 7, and specifies transmission. When the discrimination information is received in this way (FIG. 9, step S47: YES), the computer 2 transmits the discrimination information to the image providing apparatus 4 (step S48). The image providing apparatus 4 determines whether or not the discrimination information has been received (step S49), and enters reception standby mode and repeats the process until discrimination information has been received (FIG. 9, step S49: NO). When the discrimination information has been received in step S49 (FIG. 9, step S49: YES), the image providing apparatus 4 inquires of the discrimination information to the database 30 (step S50). When discrimination information does not exist in the database 30 at this time, the process ends. Furthermore, when the search for discrimination information in the database 30 produces a hit, the image providing apparatus 4 reads the low resolution images 52 from among the records corresponding to the discrimination information in the database 30. Then, the transmission of the low resolution images 52 begins. FIG. 16 is a schematic view illustrating the order of the transmission of the low resolution images 52. The image providing apparatus 4 first transmits the low resolution images 52 required for display on the screen of the image display unit 6 of the computer 2 (step S52). FIG. 16 indicates the initially displayed low resolution images 52 by a hatching pattern. Furthermore, the low resolution images 52 on the periphery (the part marked in gray in FIG. 16) surrounding the initially displayed region are not initially displayed but are included in the part required for the initial display. That is, in the first embodiment of the present invention, the parts required for the initial display include the region initially displayed and the parts on the periphery thereof. Accordingly, the initially display low resolution images 52 and the peripheral low resolution images 52, that is, the low resolution images 52 required for the initial display, are transmitted in step S51. The low resolution images 52 required for the initial display shown in FIG. 16 are examples; for example, a total of 25 low resolution images 52 including the nine 3×3 regions which are initially displayed and the peripheral parts thereof may be deemed parts required for the initial display.

The computer 2 determines whether or not the low resolution images 52 transmitted from the image providing apparatus 4 have been received (step S52), and enters a reception standby mode and repeats the process until the reception of the low resolution images 52 begins (FIG. 9, step S52: NO). When reception of the low resolution images 52 starts in step S52 (FIG. 9, step S52: YES), the computer 2 stores the received low resolution images 52 on the hard disk 11 of the computer 2. The computer 2 then displays the received low resolution images 52 in a first window 53 on the image display unit 6 (step S53). In FIG. 15, the first window 53 is arranged in the region at the top of the screen. When a scrolling operation is performed just slightly from the initially displayed condition, the previously received low resolution images 52 can be read and displayed from the local hard disk 11 without downloading the low resolution images 52 required for the display from the image providing apparatus 4 thereby providing a smooth scrolling display by simply receiving not only the region required for the initial display but also the low resolution images 52 of the parts peripheral thereto.

Furthermore, in the process of step S53, the computer 2 dynamically tiles the plurality of low resolution images 52. This dynamic tiling means that as the low resolution images 52 are seamlessly aligned to from the virtual slide (a virtual slide of lower resolution than the virtual slide 50) they are displayed in the first window 53 in the order in which they were received. When dynamic tiling, tiling is performed before creating the virtual slide 50, and dividing thereafter, and only the obtained low resolution images 52 are aligned, such that no dislocation is generating between adjacent images. Therefore, dynamic tiling differs from image tiling when creating the virtual slide, and processing time can be reduced since recognizing the overlapping parts of the images is unnecessary. Furthermore, it is possible to suppress the increase in the time required for the display since the low resolution images 52 required for the display are downloaded to the computer 2 on a priority basis in relation to the other low resolution images 52 which are not required for the display at that time.

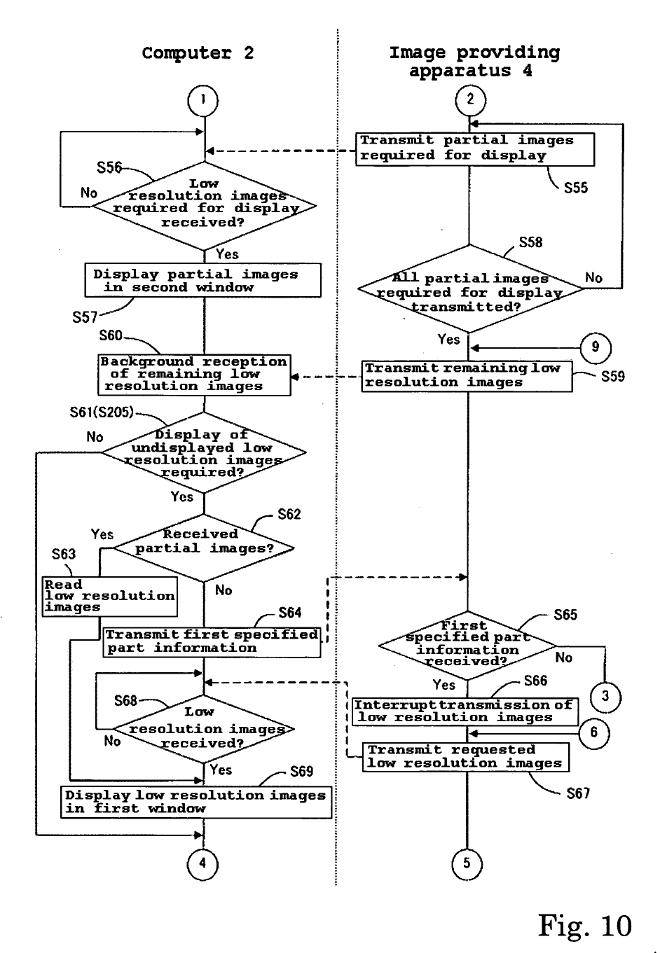

The image providing apparatus 4 determines whether or not all low resolution images 52 required for the display have been transmitted (step S54). If there are some remaining images which have not yet been transmitted at this time (FIG. 9, step S54: NO), transmission of these low resolution images 52 continues. When the transmission of the low resolution images 52 required for the initial display ends in step S54 (FIG. 9, step S54: YES), the image providing apparatus 4 transmits the partial images 51 required for the display to the screen of the image display unit 6 of the computer 2 (step S55). The partial images 51 required for the initial display are the partial images 51 of the initial display and the partial images 51 on the periphery thereof similar to the previously described low resolution images 52. The computer 2 determines whether or not the partial images 51 transmitted from the image providing apparatus 4 have been received (step S56), and enters a reception standby mode and repeats the process until the reception of the partial images 51 begins (FIG. 10, step S56: NO). When the computer 2 starts receiving the partial images 51 in step S56 (FIG. 10, step S56: YES), the received partial images 51 are stored on the local hard disk 111 of the computer 2. The computer 2 then displays the received partial images 51 in a second window 54 on the image display unit 6 (step S57). In FIG. 15, the second window 54 is arranged at the bottom part of the screen. In this way the partial images 51 equivalent to an enlargement of the microscope photograph of the smear sample captured by the 100× magnification objective lens are displayed on the image display unit 6 of the computer 2. The user is able to more closely classify the white blood cell by visually verifying the image of the cell (white blood cell) shown in the partial image 51, and confirming the morphological details of the cell by means of the low resolution image 52. Furthermore, the aforesaid dynamic tiling is accomplished even in the display of the partial images 51 in step S57. In this way it is possible to suppress the increase in the time required for the display since the partial images 51 required for the display are downloaded to the computer 2 on a priority basis in relation to the other partial images 51 which are not required for the display at that time.

The image providing apparatus 4 determines whether or not all partial images 51 required for the initial display have been transmitted (step S58). When there are remaining images which have not yet been transmitted at this time (FIG. 10, step S58: NO), the image providing apparatus 4 continues transmitting the remaining partial images 51. When the transmission of the partial images 51 required for the initial display ends in step S58 (FIG. 10, step S58: YES), the image providing apparatus 4 transmits the untransmitted low resolution images 52, that is, the low resolution images 52 which are outside the areas required for the initial display, to the computer 2 (step S59). The order of the transmission of the low resolution images 52 in step S59 is set, for example, to transmit sequentially from the top row far left (No. 1 low resolution image in FIG. 16) toward the right among the low resolution images 52 arranged in a matrix, and after transmitting the rightmost low resolution image 52 in that row (No. 20 low resolution image in FIG. 16), sequentially transmitting from the next lower row far left (Bo. 21 low resolution image in FIG. 16) toward the right, and repeating to the bottom row. At this time, the previously transmitted low resolution images 52 are excluded. That is, in FIG. 16, the low resolution images 52 are transmitted in the order No. 13 to No. 20, No. 33 to No. 40, No. 53 to No. 60.

The computer 2 continues receiving other low resolution images 52 in the background while the previously received low resolution images 52 are displayed in the first window 53. Then, the received low resolution images 52 are stored on the local hard disk 11. In this way it is possible to display the low resolution images 52 even though not all of the low resolution images 52 have been received, such that the low resolution images 52 can be displayed rapidly, and user stress is reduced. Furthermore, the classification count operation can be started quickly, thereby improving work efficiency.

For example, the user can drag the scroll bar of the window in which the low resolution images 52 are displayed so as to move the display toward the screen containing the undisplayed low resolution images 52, that is, the computer 2 can be directed to move the field of view. When an interrupt is generated by operating the input unit 7, the computer 2 displays the low resolution images 52 when they have already been received, and determines that user instructions have been received when the part of the low resolution images 52 required for the display have not been received. For example, when a user clicks the mouse on the displayed low resolution image 51, it is possible to change the display so as to position the clicked area at the center of the window. At this time, when other low resolution images 52 must be displayed n accordance with the display change (FIG. 10, step S61: YES), the computer 2 determines whether or not the low resolution image 52 has already been received (step S62), and when the image has already been received (FIG. 10, step S62: YES), the image is read from the local hard drive 11 (step S63), and displayed in the first window 53 of the image display unit 6 (step S69). When the image has not yet been received (FIG. 10, step S62: NO), however, the computer 2 transmits information specifying the low resolution images 52 required for the display (first part specified information, for example, the line number and column number of the low resolution image 52) to the image providing apparatus 4 (step S64). The processes of steps S61, S62, and S63 are executed by a multitasking process, and the reception of the low resolution images 52 from the image providing apparatus 4 is accomplished in the background of these processes.

The image providing apparatus 4 determines whether or not the first part specified information has been received (step S65), and enters a reception standby mode and repeats the process until the first part specified information has been received (FIG. 10, step S65: NO). When the first part specified information is received in step S65 (FIG. 10, step S65: YES), the image providing apparatus 4 reads the low resolution image 52 specified by the first part specification information from the database 30, and interrupts the transmission of the low resolution images 52 being transmitted at that time to transmit the requested low resolution image 52 (step S67). The computer 2 then determines whether or not the requested low resolution image 52 has been received (step S68), and enters reception standby mode until the reception of that low resolution image 52 begins (FIG. 10, step S68: NO). When reception of the low resolution images 52 starts in step S68 (FIG. 10, step S68: YES), the computer 2 displays the received low resolution images 52 in the first window on the image display unit 6. In this way the image providing apparatus 4 transmits the low resolution images 52 required for the display on a priority relative to the other low resolution images 52, such that the low resolution images 52 can be rapidly displayed and work efficiency can be improved.

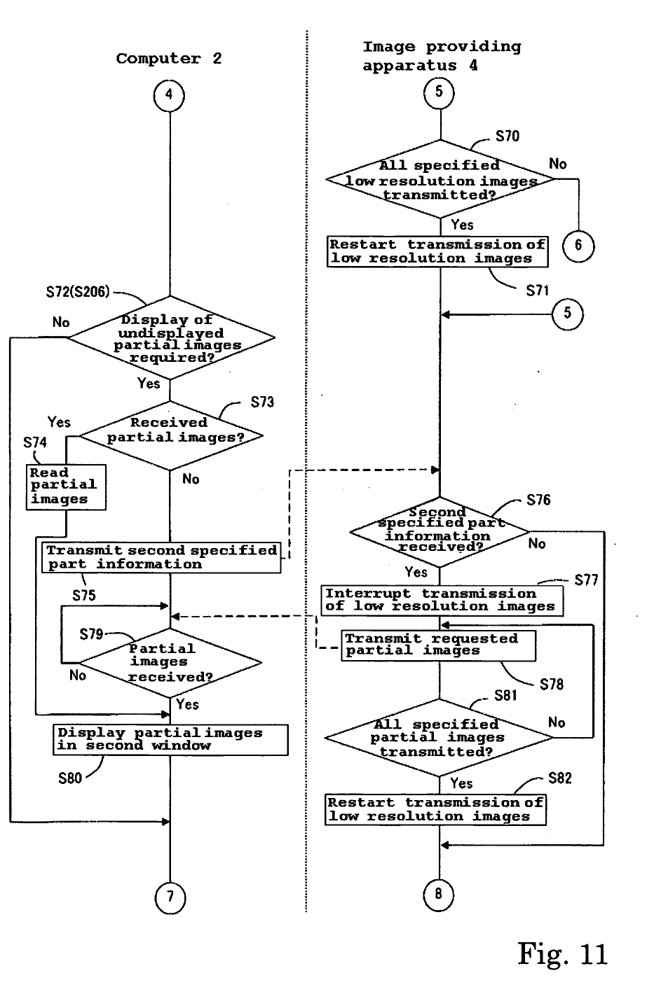

The image providing apparatus 4 determines whether or not all the low resolution images 52 specified by the first part specified information have been received (step S70). If there are some remaining images which have not yet been transmitted at this time (FIG. 11, step S70: NO), transmission of these low resolution images 52 continues. When the transmission of the low resolution images 52 specified in the first part specified information ends in step S70 (FIG. 11, step S70: YES), the transmission of the low resolution images 52 of the regions not being displayed which was interrupted in step S66 is resumed (step S71).

The user performs the cell classification count by displaying the low resolution images 52 on the computer 2. The cell (white blood cell) classification count used in the image displaying system 1 of the first embodiment is accomplished in the manner described below. In this way the low resolution images 52 equivalent to an enlargement of the microscope photograph of the smear sample captured by the 40× magnification objective lens are displayed on the image display unit 6 of the computer 2. The user visually confirms the cells (white blood cells) shown in the low resolution image 52, classifies the cells into a plurality of types based on the cell morphology, and counts each type of white blood cell. This is accomplished, for example, using a special classification keyboard (not shown in the drawings) connected to the computer 2. Specifically, the types of white blood cells are respectively allocated to a plurality of keys provided on the keyboard, and the user visually confirms the low resolution image 52, presses the key corresponding to the type of observed white blood cell, and the computer 2 counts the number of times each key is pressed. When the type of white blood cell cannot be determined from the low resolution image 52, the user then requests a high resolution image (partial image 51) showing the white blood cell by, for example, clicking the image of the white blood cell. At this time in the computer 2, an interrupt is generated requesting the display of the partial image 51. When the user generates an interrupt requesting the display of the partial image 51 by the aforesaid operation (FIG. 11, step S72: YES), the computer 2 determines whether or not this partial image 51 has already been received (step S73), and when the image has already been received (FIG. 11, step S73: YES), this image is read from the local hard drive 11 (step S74), and displayed in the second window on the image display unit 6 (step S80). When the image has not yet been received (FIG. 11, step S73: NO), however, the computer 2 transmits information specifying the partial images 51 required for the display (second part specified information, for example, the line number and column number of the partial image 51) to the image providing apparatus 4 (step S75).

The image providing apparatus 4 determines whether or not the second part specified information has been received (step S76), and enters a reception standby mode and repeats the process until the first part specified information has been received (FIG. 11, step S76: NO). When the second part specified information is received in step S76 (FIG. 10, step S76: YES), the image providing apparatus 4 reads the partial image 51 specified by the second part specification information from the database 30, and interrupts the transmission of the low resolution images 52 being transmitted at that time (step S77) to transmit the requested partial image 51 (step S78). The computer 2 then determines whether or not this partial image 51 has been received (step S79), and enters the reception standby mode and repeats the process until the partial image 51 reception begins (FIG. 11, step S79: NO). When the computer 2 starts receiving the partial images 51 in step S79 (FIG. 11, step S79: YES), the received partial image 51 is displayed in the second window of the image display unit 6 (step S80). In this way the image providing apparatus 4 can rapidly display the partial image 51 by transmitting the partial images 51 required for the display on a priority basis relative to other partial images 51, and the user can verify the morphology of the white blood cells which are difficult to verify in the low resolution images 52 by means of the high resolution partial image 51.

The image providing apparatus 4 determines whether or not all of the partial images 51 specified in the second part specified information have been received (step S81). If there are some remaining images which have not yet been transmitted at this time (FIG. 11, step S81: NO), transmission of these partial images 51 continues. Furthermore, when the transmission of the partial image 51 specified in the second part specified information is completed (FIG. 11, step S81: YES), the transmission of the low resolution images 52 of the regions not being displayed which was interrupted in step S77 is resumed (step S82).

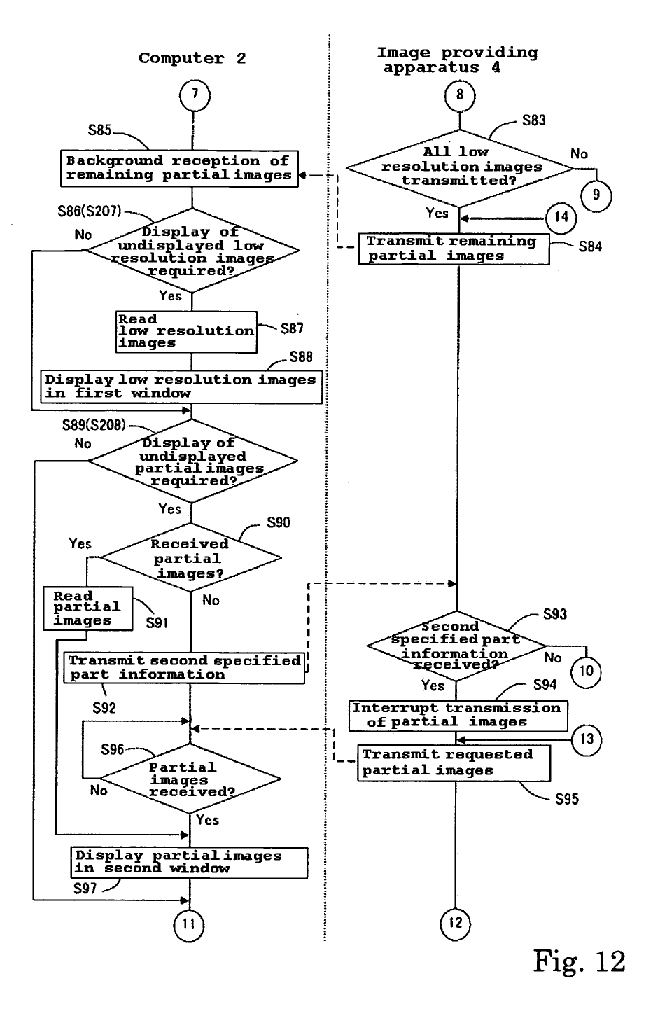

The image providing apparatus 4 then determines whether or not all low resolution images 52 corresponding to the discrimination information have been transmitted (step S83). When low resolution images 52 remain which have not yet been transmitted (FIG. 12, step S83: NO), the image providing apparatus 4 returns to the process of step S59 and continues the transmission of the low resolution images 52. When the transmission of all low resolution images 52 is completed in step S83 (FIG. 12, step S83: YES), the image providing apparatus 4 transmits the partial images 51 which have not been transmitted, that is, the partial images 51 outside the area required for the initial display (step S84). The order of the transmission of the partial images 51 is determined in the same way as the order of transmission of the low resolution images 52 described above.

The computer 2 continues receiving the other partial images 51 in the background while the previously received partial images 51 are displayed in the second window 54 (step S85). In this way it is possible to display the partial images 51 even though not all of the partial images 51 have been received, such that the partial images 51 can be displayed rapidly, and user stress is reduced. Furthermore, the classification count operation can be started quickly, thereby improving work efficiency.

For example, as described previously, the user can drag the scroll bar of the window in which the low resolution images 52 are displayed so as to generate an interrupt requesting the display of the low resolution images 52 which are not currently displayed to specify moving the field of view. Since the computer 2 has already received all the low resolution images 52 when the interrupt is generated (FIG. 12, step S86: YES), the appropriate low resolution images 52 are read from the local hard disk 11 (step S87), and displayed in the first window 53 on the image display unit 6 (step S88).

For example, when the user clicks the image of the white blood cell in the low resolution image 52, an interrupt is generated requesting the display of the partial image 51 which include the image of this white blood cell in the computer 2. The computer 2 determines whether or not this partial image 51 has already been received when the interrupt is generated (FIG. 12, step S89: YES), and when the partial image 52 has already been received (FIG. 12, step S90: YES), the appropriate partial image 51 is read from the local hard disk 11 (step S91), and displayed in the second window 543 on the image display unit 6 (step S97). When the image has not yet been received (FIG. 12, step S90: NO), however, the computer 2 transmits information specifying the partial images 51 required for the display to the image providing apparatus 4 (step S92). The image providing apparatus 4 determines whether or not the second part specified information has been received (step S93), and enters a reception standby mode and repeats the process until the second part specified information has been received (FIG. 12, step S93: NO). When the second part specified information is received in step S93 (FIG. 12, step S93: YES), the image providing apparatus 4 reads the partial image 51 specified by the second part specification information from the database 30, and interrupts the transmission of the partial images 51 being transmitted at that time (step S94) to transmit the requested partial image 51 (step S95). The computer 2 then determines whether or not this partial image 51 has been received (step S96), and enters the reception standby mode and repeats the process until the partial image 51 reception begins (FIG. 12, step S96: NO). When the computer 2 starts receiving the partial images 51 in step S96 (FIG. 12, step S96: YES), the received partial images 51 are displayed in the second window 54 of the image display unit 6 (step S97). In this way the image providing apparatus 4 can rapidly display the partial image 51 by transmitting the partial images 51 required for the display on a priority basis relative to other partial images 51, and the needed partial image 51 can be rapidly displayed, thereby improving work efficiency.

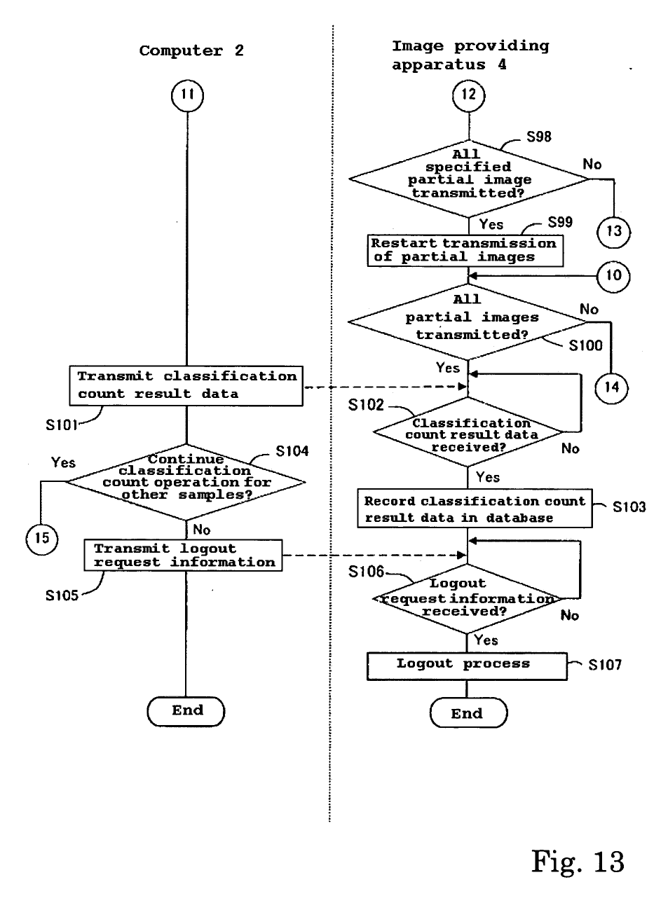

The image providing apparatus 4 determines whether or not all of the partial images 51 specified in the second part specified information have been received (step S98). If there are some remaining images which have not yet been transmitted at this time (FIG. 13, step S98: NO), transmission of these partial images 51 continues. Furthermore, when the transmission of the partial image 51 specified in the second part specified information is completed (FIG. 13, step S98: YES), the transmission of the partial images 51 of the regions not being displayed which was interrupted in step S94 is resumed (step S99).

The image providing apparatus 4 then determines whether or not all partial images 51 corresponding to the discrimination information have been transmitted (step S100). When there remain some partial images 51 which have not yet been transmitted (FIG. 13, step S100: NO), the process returns to step S84, and the transmission of the partial images 51 continues. The user performs the white blood cell classification count using the computer 2. When the work of the white blood cell classification count is completed, the computer 2 transmits the classification count result data to the image providing apparatus 4 (step S101). The image providing apparatus 4 determines whether or not the classification count result data have been received (step S102), and enters the reception standby mode and repeats the process until the classification count result data are received (FIG. 13, step S102: NO). Furthermore, when the classification count result data are received in step S102 (FIG. 13, step S102: YES), the image providing apparatus 4 records the classification count result data in the database 30 (step S103). The computer 2 then receives the selection from the user indicating whether or not a classification count operation is to be performed for another sample (step S104). This is possible by determining by detecting whether or not the user has input logout instructions. In this way a user can select whether or not to perform a classification count operation for another sample. When a further classification count operation is performed at this time, that is, when the computer 2 does not receive logout instruction input from the user (FIG. 13, step S104: YES), the computer 2 returns to the process of step S47, and receives the discrimination information input. Furthermore, when the classification count operation ends in step S104, that is, when the computer 2 receives logout instruction input (FIG. 13, step S104: NO), the computer 2 transmits logout request information to the image providing apparatus 4 (step S1105). The image providing apparatus 4 then receives the logout request information (FIG. 13, step S106: YES), and after the database 30 logout process (step S107) ends, this process ends. Thus, the classification count operation ends.

According to the construction described above, low resolution images 52 required for display are transmitted and received between the image providing apparatus 4 and the computer 2 on a priority basis relative to other low resolution images 52 which are not required for display at that time, and, similarly, partial images 51 which are required for display are also transmitted and received on a priority basis relative to other partial images 51 which are not required for display at that time, and therefore, the computer 2 can display the low resolution images 52 and partial images 51 immediately of the partial images 51 have been received, such that the images can be displayed more rapidly than in the convention art. Furthermore, since the computer 2 receives the other (as yet untransmitted) low resolution images 52 and partial images 51 in the background while the previously received low resolution images 52 and partial images 51 are being displayed, image display and reception are accomplished with even greater efficiency.

In the first embodiment, the image providing apparatus 4 transmits low resolution images 52 required for the initial display, then the partial images 51 required for the initial display are transmitted, and the computer 2 displays the received low resolution images 52 and partial images 51 required for the initial display on the image display unit 6; thereafter, the image providing apparatus 4 transmits the as yet untransmitted low resolution images 52 and partial images 51, and the computer 2 receives the these low resolution images 52 and partial images 51 in the background. However, the sequence of the transmission of the low resolution images 52 and partial images 51 is not limited to the structure of the first embodiment. For example, the image providing apparatus 4 transmits the other low resolution images 52 after having transmitted the low resolution images 52 which are required for the initial display, and the computer 2 displays the first received low resolution images 52 on the image display unit 6 while receiving all the remaining low resolution images 52 in the background; thereafter, the image providing apparatus 4 transmits the partial images 51 required for the initial display, then transmits the as yet untransmitted partial images 51, and the computer 2 displays the first received partial images 51 on the image display unit 6 while receiving all the remaining partial images 51 in the background.

### Second Embodiment

The operation of the image displaying system of the second embodiment of the present invention is described below. The structure of the image displaying system 101 (refer to FIG. 1) of the second embodiment of the present invention is identical to the structure of the image displaying system 1 of the first embodiment, and, therefore, like structural elements are identified by like reference numbers, and their further description is omitted herefrom. Although the computer 102 and computer 104a of the second embodiment have the same hardware structures as the computer 2 and computer 4a of the first embodiment, and, their further description is omitted, they function as the image displaying apparatus and image providing apparatus 4 of the second embodiment of the present invention which is accomplished by executing respective computer programs of the second embodiment, and their operations are described below.

In the virtual slide recording operation of the image displaying system 101 of the second embodiment of the present invention, the low resolution image 52 is the partial image and the partial image generally contains the image of only one cell; a partial image (hereinafter referred to as “discrete cell image”) 61, which is used to confirm individual cells, is also recorded. The discrete cell image 61 may be created, for example, by extracting a square region which contains the image of a target cell and its periphery from the low resolution image 52, or by extracting a square region which contains the image of a target cell and its periphery from the virtual slide 50 or partial image 51 and reducing the resolution of the partial image. In this way the low resolution image 52 of the image of the cell of the discrete cell image 61 is included, and the position information representing the position of the low resolution image 52 of the image of the cell of the discrete cell image 61 is associated with the discrete cell image 61 and recorded in the database 30. That is, it is possible to specify the location of the low resolution image 52 of the cell of the discrete cell image 61 by means of the position information associated with the discrete cell image 61. In the second embodiment, for example, the discrete cell image is 150×150 dots and saved in full color PNG format and its position (X,Y) on the virtual slide is saved as position information.

The discrete cell image 61 includes at least the image of one target cell, but may also include an image of a plurality of cells by cell size and presence adjacent to the target cell on the periphery thereof. In this case, however, the discrete cell image 61 is created such that the image of the target cell is usually positioned in the center of the image, and the image of the target cell of the discrete cell image 61 is easily recognized by the user in the discrete cell image 61.

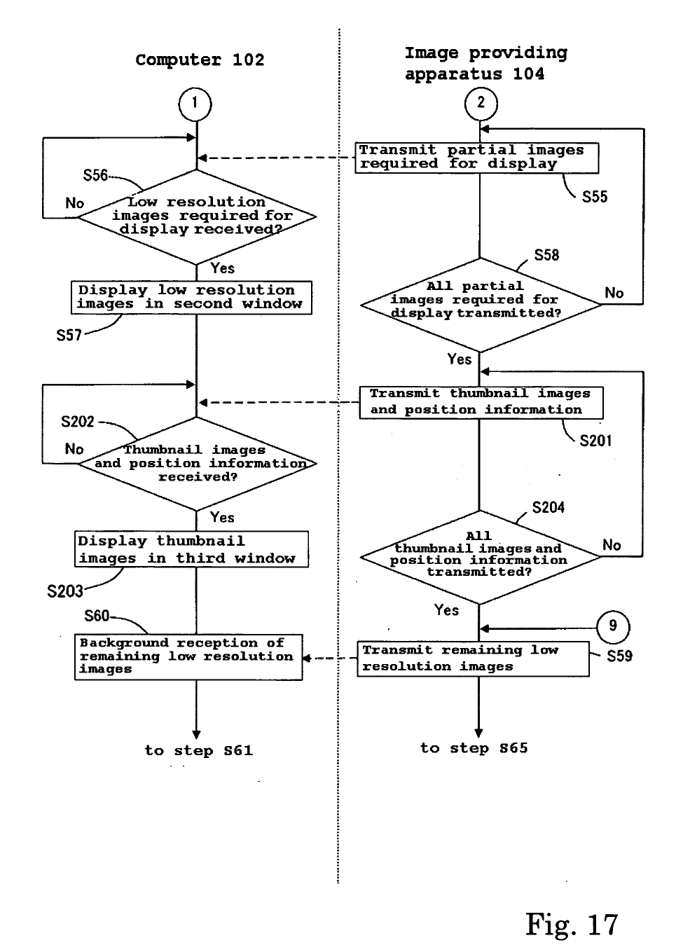

FIG. 17 is a flow chart showing part of the sequence of the classification count operation of the image display system 101 of a second embodiment of the present invention. The image displaying system 101 of the second embodiment performs processing identical to the classification count operation of the image displaying system 1 of the first embodiment with the exception of processing specifically described below in the classification count operation, and, therefore, identical step numbers are referenced in both processes and further description is omitted below. As shown in FIG. 17, when the transmission of the partial images 51 required for the initial display ends in step S58 (FIG. 17, step S58: YES), the image providing apparatus 104 reads the discrete cell image 61 corresponding to the discrimination information and the position information from the database 30, and transmits the data to the computer 102 (step S201).

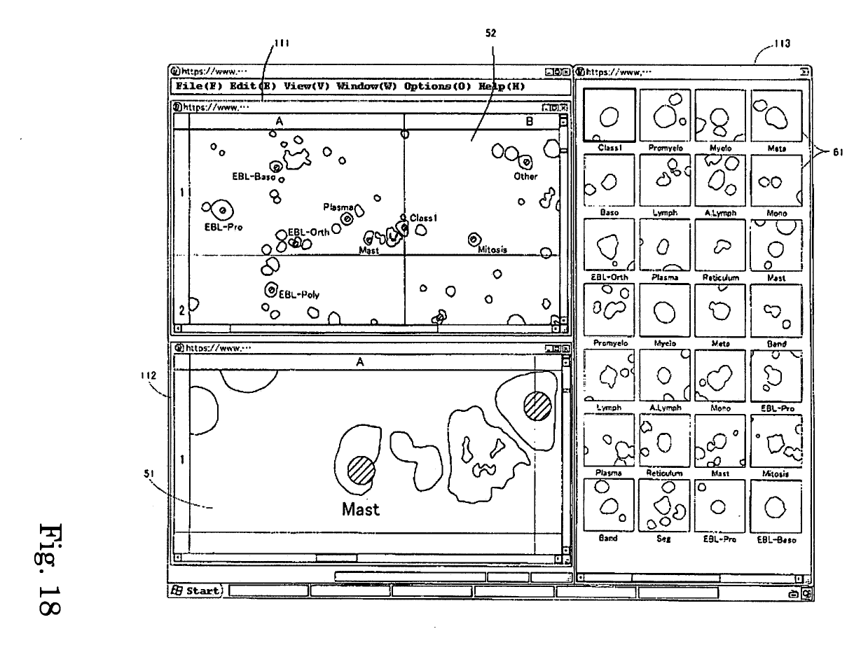

The computer 102 determines whether or not the discrete cell image 61 and position information have been received from the image providing apparatus 104 (step S202), and enters reception standby mode and repeats the process until reception of the discrete cell image 61 and position information begins (FIG. 17, step S202: NO). Furthermore, when the discrete cell image 61 and position information reception has started in step S202 (FIG. 17, step S202: YES), the computer 102 displays the received discrete cell image 61 in a third window 113 on the image display unit 6 (step S203). FIG. 18 shows an example of a screen display of the computer 102 in the white blood cell classification count operation by the image display system of the second embodiment of the present invention. In FIG. 18, a first window 111 is arranged at the top left region of the screen, a second window 112 is arranged at the bottom left region of the screen, and the third window 113 is arranged in the center region of the screen.

The image providing apparatus 104 determines whether or not all discrete cell image s61 and position information have been received (step S204). If there are any as yet untransmitted discrete cell images 61 and position information remaining at this time (FIG. 17, step S204: NO), the reception of the discrete cell images 61 and position information continues. When the reception of the discrete cell images 61 and position information ends in step S204 (FIG. 17, step S204: YES), the process advances to step S59.

As shown in FIG. 18, the discrete cell images 61 are aligned a matrix pattern within the third window 113. Since a plurality of discrete cell images 61 can be displayed at once in this way, the user can readily view the discrete cell image 61 which contains the image of the desired cell. Clicking on the discrete cell image 61 associates the read position information corresponding to the clicked discrete cell image 61. When one discrete cell image 61 has been clicked, the computer 102 reads the associated position information and the display is changed such that the position (position at which the image of the cell exists) within the low resolution image 52 is placed in the center of the first window 111, and the partial image 51 of the target cell is displayed in the second window 112. That is, when the user clicks on a discrete cell image 61, a display change event is generated in the first window 111 and a display change event is generated in the second window 112.

When an interrupt is generated to change the display of the first window 111 (step S205: YES (refer to FIG. 10), or step S207: YES (refer to FIG. 12)), the computer 102 executes the process of step S62 or step S87 and subsequent steps described in the first embodiment. Furthermore, when an interrupt is generated to change the display of the second window 112 (step S206: YES (refer to FIG. 11), or step S208: YES (refer to FIG. 12)), the computer 102 executes the process of step S73 or step S90 and subsequent steps described in the first embodiment. That is, when a first window 111 display change event or a second window 112 display change event is generated by the user clicking on a discrete cell image 61 (steps S205, S206, S207, S208) and the computer 102 has already received the low resolution images 52 and partial images 51 required for the display at this time (steps S62, S73, S90: NO), the computer 102 reads the respective image data from the local hard disk 11 (steps S63, S74, S87, S91), or, when the low resolution images 52 and partial images 51 required for the display have not yet been received (steps S62, S73, S90: YES), transmits a transmission request (first part specified information and second part specified information) to the image providing apparatus 104 requesting the transmission of these low resolution images 52 and partial images 51 on a priority basis relative to other low resolution images 52 and partial images 51 (steps S64, S75, S92). In this way only the required images are rapidly displayed without downloading all image data by means of the prioritized download of the images required for the display.

In the second embodiment, the discrete cell image 61 is described as an image easily recognized to be either an image of the target cell only, or an image of a target cell which also includes a plurality of cell images. However, a discrete cell image 61 may also be created which includes a plurality of cell images. For example, a square region which includes a plurality of cell images may be extracted and reduced to produce a discrete cell image 61. In this way the user can, for example, visually confirm the density of the cell distributed at a specific position on the virtual slide, which can be used when diagnosing illness.

### Third Embodiment

The operation of the image displaying system of the third embodiment of the present invention is described below. The structure of the image displaying system 201 (refer to FIG. 1) of the third embodiment of the present invention is identical to the structure of the image displaying system 1 of the first embodiment, and, therefore, like structural elements are identified by like reference numbers, and their further description is omitted herefrom. Although the computer 202 and computer 204a of the second embodiment have the same hardware structures as the computer 2 and computer 4a of the first embodiment, and, their further description is omitted, they function as the image displaying apparatus and image providing apparatus 204 of the third embodiment of the present invention which is accomplished by executing respective computer programs of the third embodiment, and their operations are described below. The virtual slide recording operation by the image display system 201 of the third embodiment of the present invention is identical to the virtual slide recording operation of the image displaying system 1 of the first embodiment, and further description is therefore omitted.

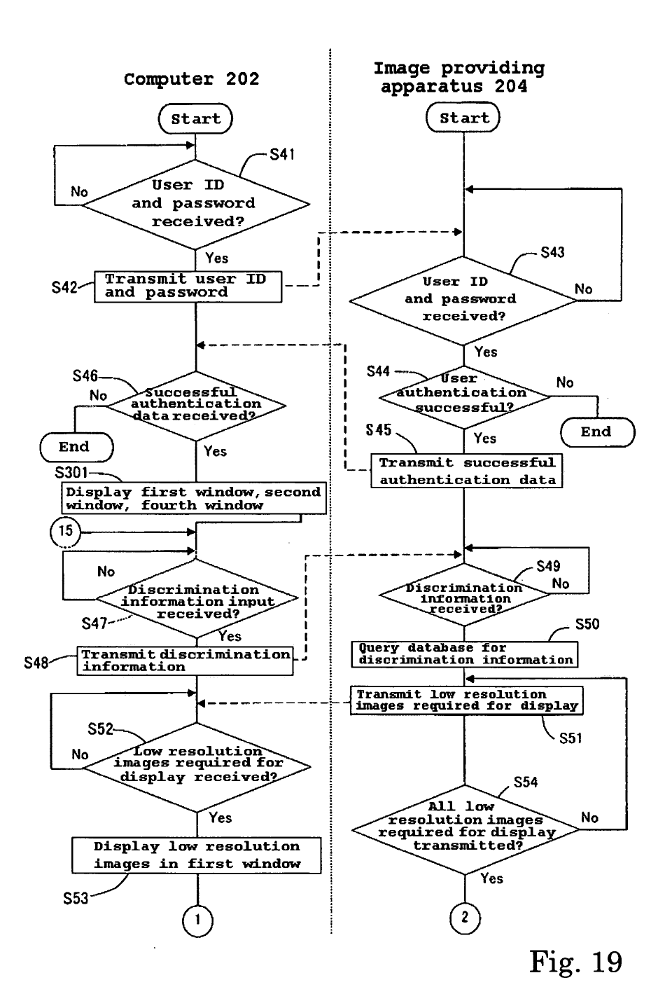

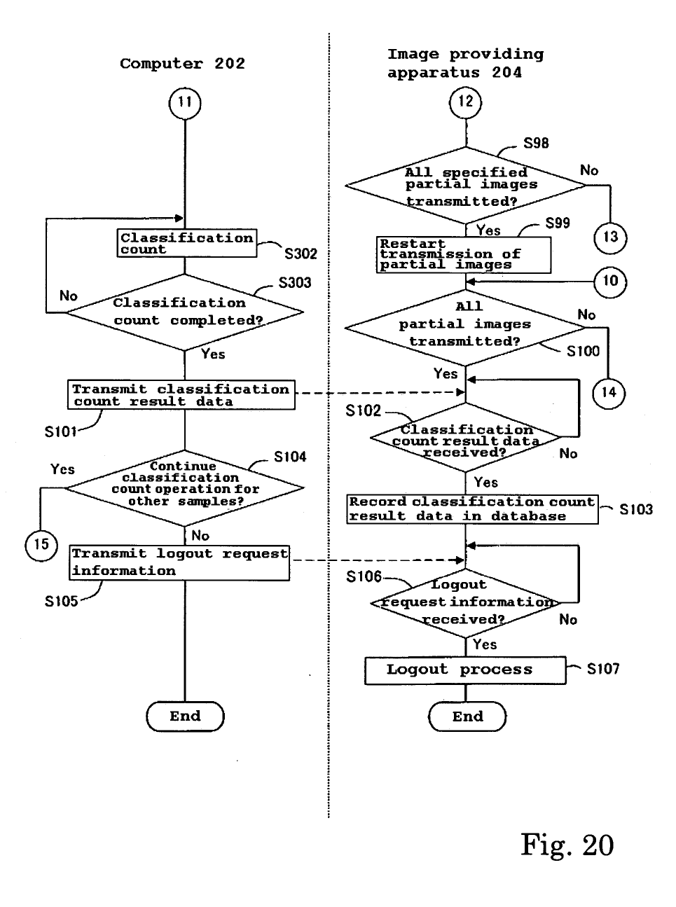

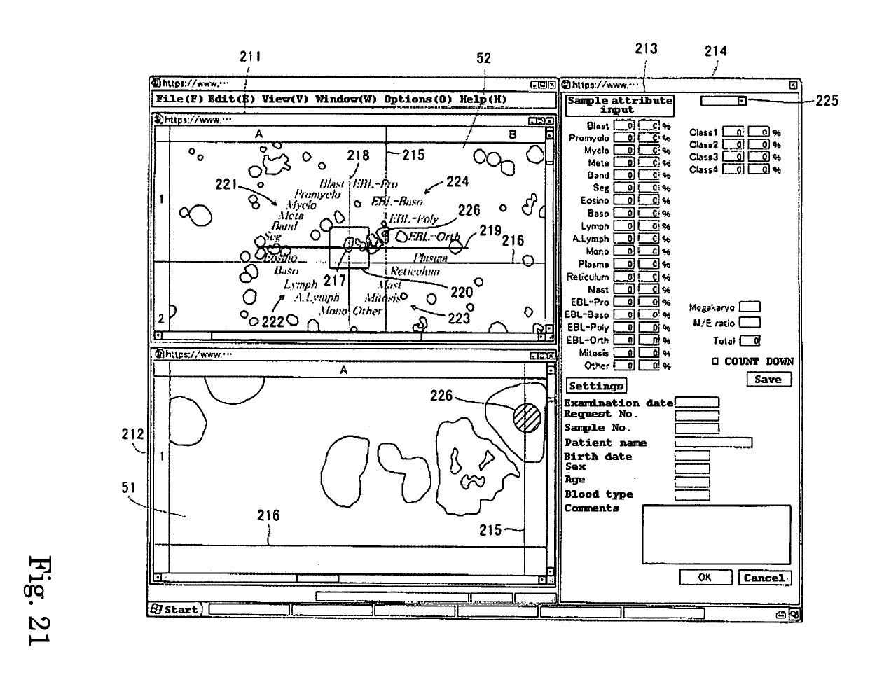

FIGS. 19 and 20 are flow charts showing part of the sequence of the classification count operation of the image display system 201 of the third embodiment of the present invention, and FIG. 21 shows an example of a screen display of the computer 202 in the white blood cell classification count operation by the image display system of the third embodiment of the present invention The image displaying system 201 of the third embodiment performs processing identical to the classification count operation of the image displaying system 1 of the first embodiment with the exception of processing specifically described below in the classification count operation, and, therefore, identical step numbers are referenced in both processes and further description is omitted below. As shown in FIGS. 19 and 21, in the image displaying system 201 of the third embodiment, after the computer 202 has received the successful authentication data in step S46, that is, after the user has successfully logged into the database 30, the computer 202 displays a fourth window 214 for displaying a classification count display 213 used in displaying results of the cell classification count operation on the image display unit 6, in addition to the first window (first region of the present invention) 211 for displaying the low resolution images 51 and the second window (second region of the present invention) 212 for displaying the partial images 51 (step S301).

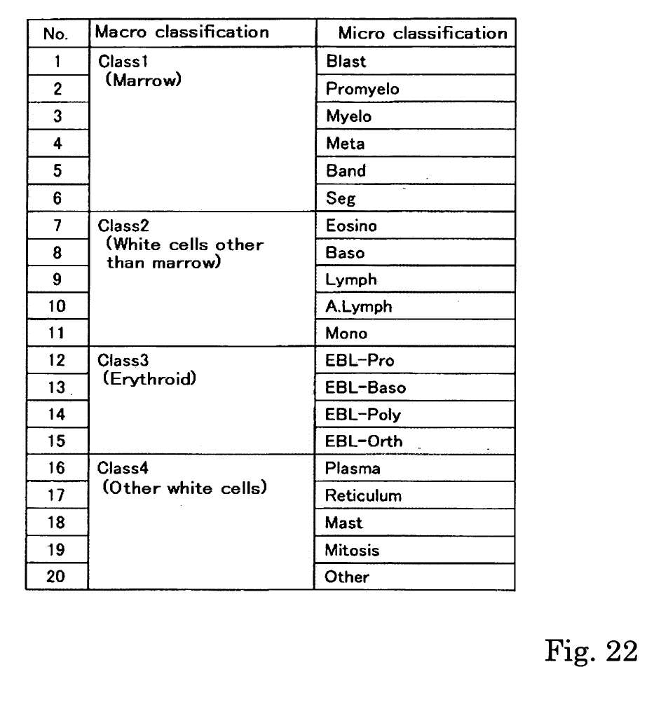

The numbers and percentages (%) of twenty types of white blood cells of micro classification, and numbers and percentages (%) of four types of white blood cells of macro classification (Class1˜Class4) are displayed on the classification count display 213. FIG. 22 illustrates the white blood cell classification count items in the third embodiment of the present invention. The micro classification of twenty types of white blood cells shown in FIG. 21 includes blast, promyelo, myelo, meta, band, seg, eosino, baso, lymph, A. lymph (anomalous), mono, EBL-Pro, EBL-Baso, EBL-Poly, EBL-Ortho, plasma, reticulum, mast, mitosis, and other, as shown in FIG. 22. The macro classification of four types of white blood cells shown in FIG. 10 consists of, in the aforesaid twenty types of micro classification, Class1 (marrow) including blast, promyelo, myelo, meta, band, and seg; Class2 (white cells other than marrow) including eosino, baso, lymph, A. lymph, and mono; Class3 (erythroid) including EBL-Pro, EBL-Baso, EBL-Poly, and EBL-Ortho; and Class4 (other white cells) including plasma, reticulum, mast; mitosis, and other.

Since a user, such as a laboratory technician or physician, considers detailed classification after determining the macro classification of the cell when counting blood cells (white blood cells), the categories of macro and micro classifications shown in FIG. 22 conform to this counting procedure.

Furthermore, attribute information including the examination day, request number, sample number, patient name, birth date, sex, age, blood type, sample comments and the like are displayed in the classification count window 213. Attribute information may also be input in the classification count window 213. When attribute information is input, an input screen (not shown in the drawing) is displayed as a separate window by clicking the [sample attribute input] button. In the input screen, input attribute information is displayed in the classification count display 213 by inputting the attribute information. The megakaryo box of the classification count display 213 allows input and display of the density (many+, few−) of megakaryocytes. The classification count display 213 also shows the M/E ratio representing the ratio of M cells to E cells, and the total counts. When the [setting] button is clicked on the classification count display 213, it is possible to enters the settings for the micro classification item names, and which micro classifications are associated with which macro classifications.

The [save] button and [OK] button on the classification count display 213 are used when saving the classification results to the computer 202. The [cancel] button is used when the classification results are not saved to the computer 202. The [count down] check box is used when revising (editing) the classification results.

After the classification count display 213 has been displayed, the user conducts the classification count for the virtual slide displayed in the first window 211 and second window 212. The computer 202 executes the classification count process (step S302). Although the classification count is described as being conducted after the process of step S100, that is, after all low resolution images 52 and partial images 51 have been downloaded to the computer 202 in order to simplify the description, the classification count is actually conducted by the user as described below while computer 202 receives the low resolution images 52 and partial images 51 in the background. The classification count method using the virtual slide in step S302 is described in detail below. In the third embodiment, the 40× (weak magnification) virtual slide (low resolution images 52) displayed in the first window 211 and the 100× (high magnification) virtual slide 50 (partial images 51) displayed in the second window 212 are used in the classification count. Position normal lines 215 and 216 for standardizing the position of the cell image are displayed in the first window 211 and second window 212. Furthermore, letters ([A], [B]) and numbers ([1], [2]) indicating the region segmented by the position normal lines 215 and 216 are also displayed in the first window 211 and second window 212. The position normal lines 215 and 216 are switchable so as to either be displayed or not displayed.

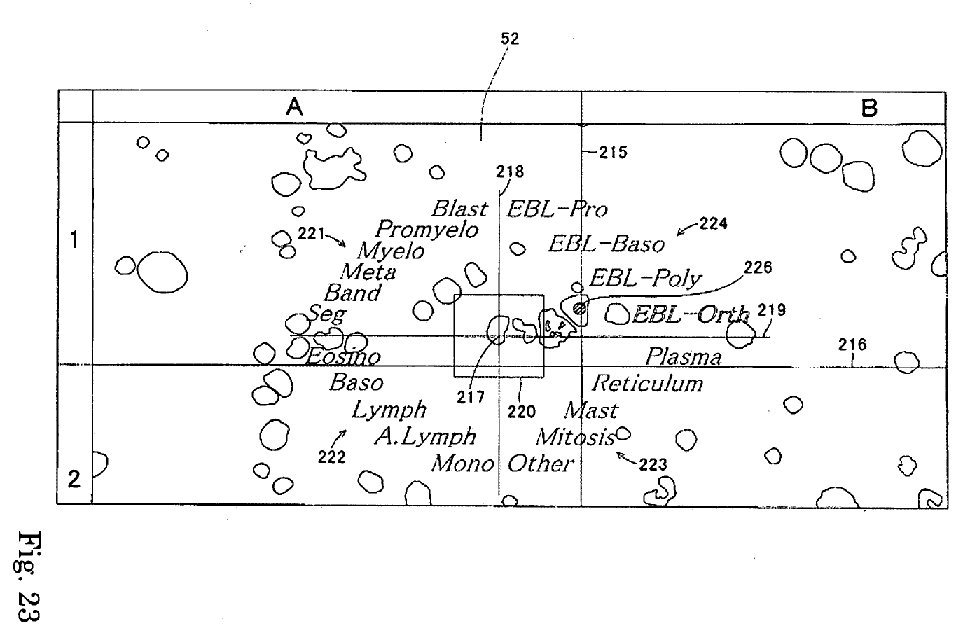

FIG. 23 is an enlargement of the first window shown in FIG. 21. When conducting the classification count, first, the mouse cursor is aligned over the cell position (specified cell position) 217 to classify within the virtual slide displayed in the first window 211. Then, when the left mouse button is pressed and held at the specified cell position 217 and the mouse cursor is moved slightly while the left button is held down (a so-called dragging operation), text, for example, a black text, pops up indicating the classification of the cells (micro classification) of twenty types of white blood cells so as to create a virtual circle with the specified cell position 217 at the center, as shown in FIGS. 21 and 23. The text is displayed so as to be transparent to the background such that the cell images in the region delineated by the text are visible.

Division lines 218 and 219 pass through the specified cell position 217 so as to be mutually perpendicular divide the four macro classifications to which the micro classifications below displayed in an approximate circle, that is, Class1 (marrow) 221, class2 (nonmarrow) 222, Class3 (erythroid) 223, Class4 (other). A square border line 220 is displayed in the virtual slide to regulate the boundary of the micro classification selection region and macro classification selection region centered on the specified cell position 217. The borderline 220 is displayed in red, for example, so as to be easily visible.

The name (for example, EBL-Ortho) of a selected micro cell classification is displayed reversed from black to red by moving the mouse cursor to the position corresponding with the name of the selected micro cell classification within the micro classification selection region on the inner side of the borderline 220 while the macro and micro classification are displayed. The micro classification is selected in this way. When it is difficult to determine to which micro classification the cell belongs, the names of all micro cell classifications belonging to a selected macro classification are reversed from black to red by moving the mouse cursor to the region of the selected macro classification quadrant outside the borderline 220 while pressing and holding the left mouse button as the macro classifications 221˜224 and micro classifications are displayed. The macro classification is selected in this way. Thus, either micro classification or macro classification can be selected. Thereafter, by releasing the left mouse button, the selected micro classification or macro classification is counted, and the total count value for the classification corresponding to the micro or macro classification selected on the classification count display 213 of FIG. 23 is displayed. At the same time as this count, the count value, counted cells of the discrete cell image, position information, classification, classification time, classifiers name and the like are saved as classification result data to the computer 202. Although this process is described as a cell classification count operation in the third embodiment, this process is not usable for only a cell classification count, inasmuch as it may also be used, for example, when a physician visually confirms the morphology of a cell in the diagnosis of disease.

Thus, in the third embodiment, the cell images of counted cells and their position information are saved to the computer 202 simultaneously with the classification count, such that the cell images can be easily searched based on the stored position information. Furthermore, operating characteristics are improved because micro classification is selected by operating a mouse button when a popup menu is displayed which includes twenty types of micro classifications of white blood cells in the first window in which the virtual slide is scrollable, and the mouse can be used in the classification count operation for micro classification selection and the like as well as for scrolling the virtual slide by displaying the count value corresponding to the selected micro classification in the classification count display 2123. In this way the classification count operation can be performed efficiently using the virtual slide. Operating characteristics are further improved because it is possible to perform the classification count operation by a single mouse click (depressing and releasing the mouse button).

Mutually different sounds may be played for the four macro classification when the selected macro classification is saved. In this way saving the macro classification can be verified not only visually but also aurally, such that when a macro classification has been mistakenly selected, the user can be aurally aware of the erroneous selection when visually unaware of the erroneous selection. In this way it is possible to reduce erroneous selections during the classification count.

A circle mark 226 indicating that a cell has been classified may be displayed in red in the cell image for which the classification count has been saved. In this way the classification count of step S302 ends for one cell.

The computer 202 determines whether or not the classification count has been completed for a preset count number of the displayed virtual slide (step S303), and when it is determined that the preset count number have not been completed (FIG. 20, step S303: NO), the classification count process of step S302 repeats. In the case of peripheral blood, the classification count is set at approximately 100, and in the case of marrow blood, the count is set at approximately 500˜1000. The count number is set by clicking the tab 225 on the pull down menu of the classification count display 213 in FIG. 21 and selecting a count number from among a plurality of displayed count numbers. Furthermore, when the preset count number has been completed for the displayed virtual slide (FIG. 20, step S303: YES), the computer 2 returns to the process of step S101 and the classification count result data are uploaded to the image providing apparatus 4.

In the first through third embodiments described above, a virtual slide 50 is created suing a 100× objective lens, and low resolution images 52 are created which are equivalent to an image created using a 40× objective lens as a low resolution partial image 52 of the virtual slide 50; however, the present invention is not limited to this arrangement inasmuch as, for example, the virtual slide 50 and partial images 51 may be created using a 100× objective lens, and the low resolution images 52 may be created using a 40× objective lens, and furthermore, the virtual slide 50 and partial images 51 may be created using a high resolution CCD camera, and the low resolution images 52 may be created by a low resolution CCD camera using two CCD cameras having different resolutions and a single objective lens.

The first through third embodiments have been described in terms of a classification count operation and blood diagnosis operation using low resolution images 52 which are equivalent to images created using a 40× objective lens, and a virtual slide 50 and partial images 51 created using a 100× objective lens. However, image of different magnifications may be created and used in these operations. For example, in the case of smear samples using peripheral blood, low resolution images which are equivalent to images created using an objective lens having a magnification of less than 20×, and partial images which are equivalent to images created using an objective lens having a magnification of 40×˜60× may be created, so as to perform detailed classification count operation and blood diagnosis operation using the partial images, and using the low resolution images for coarse observations of the types of cell appearing in the sample, and to discover the condition of the samples (presence of damage and the like). In the case of marrow samples, the low resolution images may be created using a 40× objective lens and the partial images may be created which are equivalent to images created using a 100× objective lens, so as to perform detailed classification count operation and blood diagnosis operation using the partial images, and using the low resolution images for coarse observations of the types of cell appearing in the sample, and to discover the condition of the samples (presence of damage and the like).

Furthermore, although the low resolution images 52 are displayed in the first window 53, 111, 211, the partial images 51 are displayed in the second window 54, 112, 212, the discrete cell image 61 is displayed in the third window 113, and the classification count display 213 is displayed in the fourth window 214, the invention is not limited to this arrangement inasmuch as the low resolution images 52 partial images 51, discrete cell images 61, and classification count display 213 may be respectively displayed in separate frame within the same window.

Although the first through third embodiments have been described in terms of dividing allow resolution virtual slide into a plurality of low resolution images 52 which are then downloaded from the image providing apparatus 4, 104, 204 to a computer 2, 102, 202, the present invention is not limited to this arrangement. For example, when the size of the low resolution virtual slide is reduced so as to be completely displayable in the first window 53, 111, 211, and the time required to download the entire virtual slide does not essentially delay the start of the classification count operation, the entire virtual image may be downloaded at once from the image providing apparatus 4, 104, 204 to the computer 2, 102, 202.

According to the image displaying system, image providing apparatus, image displaying apparatus, and recording medium for recording computer programs of the present invention, partial images of areas required for the display are transmitted and received on a priority basis relative to other partial images among images of cells, such that the image can be displayed immediately if these partial images have been received, thereby providing faster display of the cell images than the conventional art. Furthermore, since other (as yet unreceived) partial images are received in the background while the previously received partial images art being displayed, image display and reception can be accomplished even more efficiently, enhancing the effect of the present invention.

What is claimed is:

1. An image displaying system comprising:
an image providing apparatus comprising a first transmitting means for transmitting a first image of a cell, and a second transmitting means for transmitting a second image of a higher resolution than the first image of the cell shown in the first image; and
an image displaying apparatus comprising an image display unit, a first receiving means for receiving the first image transmitted from the image providing apparatus, a second receiving means for receiving the second image transmitted from the image providing apparatus, a first display means for displaying the first image in a first region of the image display unit, and a second display means for displaying the second image in a second region of the image display unit,
wherein the second transmitting means transmits partial images required for display by the second display means on a priority basis relative to the other partial images among a plurality of partial images of the segmented second image, and the second receiving means receives the partial images transmitted from the image providing apparatus while previously received partial images are displayed on the second display means.

2. The image displaying system of claim 1, wherein the first transmitting means transmits partial images required for display by the first display means on a priority basis relative to the other partial images among a plurality of partial images of the segmented first image, and the first receiving means receives the partial images of the first image transmitted from the image providing apparatus while previously received partial images are displayed on the first display means.

3. The image displaying system of claim 2, wherein the image displaying apparatus further comprises a first specification reception means for receiving from a user a specification of parts required for display in the first image, and a transmitting means for transmitting first part specified information specifying the parts required for display in a first image to the image providing apparatus, the image providing apparatus further comprises a receiving means for receiving the assigned part information transmitted from the image displaying apparatus, and the first transmitting means transmits the partial images of the first image specified by the first assigned part information received by the receiving means on a priority basis relative to other partial images.

4. The image displaying system of claim 3, wherein the image displaying apparatus further comprises a determining means for determining whether or not the partial images of the parts specified by the specification from the user received by the first specification reception means have already been received, and the transmitting means transmits the first part specified information to the image providing apparatus when the determining means determines that the partial image has not been received.

5. The image displaying system of claim 3, wherein the image displaying apparatus further comprises a second specification reception means for receiving from a user a specification of parts required for display in the second image, and a transmitting means for transmitting second part specified information specifying the parts required for display in a second image to the image providing apparatus, the image providing apparatus further comprises a receiving means for receiving the second part specified information transmitted from the image displaying apparatus, and the second transmitting means transmits the partial images of the second image specified by the second part specified information received by the receiving means on a priority basis relative to other partial images.

6. The image displaying system of claim 5, wherein the image displaying apparatus further comprises a determining means for determining whether or not the partial images of the parts specified by the specification from the user received by the second specification reception means have already been received, and the transmitting means transmits the second part specified information to the image providing apparatus when the determining means determines that the partial image has not been received.

7. The image displaying system of claim 5, wherein when there is a conflict between the transmission of the partial images of the first image specified by the first part specified information and the transmission of the of the partial images of the second image specified by the second part specified information, the first transmitting means transmits the partial images of the first image specified by the first part specified information and thereafter the second transmitting means transmits the partial images of the second image specified by the second part specified information.

8. The image displaying system of claim 3, wherein the image providing apparatus further comprises a third transmitting means for transmitting discrete cell images which are partial images that contain the image of only one cell and these are partial images of the first image, the image displaying apparatus further comprises a third receiving means for receiving the discrete cell images transmitted from the image providing apparatus, and a third display means for displaying the discrete cell images received by the third receiving means in a third region of the image display unit, and the first specification reception means receives a specification of parts containing an image of the cell in the discrete cell image in the first image as the part required for the display when instructions from a user specifying one discrete cell image is received.

9. The image displaying system of claim 2, wherein the first transmitting means transmits the partial images of the first image required for the initial display on a priority basis relative to the other partial images, and the second transmitting means transmits the partial images of the second image required for the initial display on a priority basis relative to other partial images after the first transmitting means transmits the partial images required for the initial display of the first image.

10. The image displaying system of claim 2, wherein the second transmitting means interrupts the transmitting of data while the first transmitting means transmits the partial images of the first image required for the display.

11. The image displaying system of claim 10, wherein the first transmitting means interrupts the transmitting of data while the second transmitting means transmits the partial images of the second image required for the display, except when transmitting partial images of the first image required for the display.

12. The image displaying system of claim 1, wherein the cells shown in the first and second images are blood cells, and the image displaying apparatus further comprises a fourth display means for displaying a classification count display used to display the cell classification and count results in order to classify the cells, or classify and count the cells in a fourth region of the image display unit.

13. The image displaying system of claim 6, wherein the image displaying apparatus further comprises a memory for memorizing a partial image received by the second receiving means, the second display means displays the partial image memorized by the memory when the determining means determines that the partial image has been received.

14. An image providing apparatus comprising:
a first transmitting means for transmitting a first image of a cell; and
a second transmitting means for transmitting a second image of a higher resolution than the first image of the cell shown in the first image,
wherein the second transmitting means transmits the partial images required for display on an external device among a plurality of partial images of the segmented second image.

15. An image displaying apparatus comprising:
an image display unit;
a first receiving means for receiving a first image showing cells from an external device;
a second receiving means for receiving from an external device a second image of a higher resolution than the first image of the cell shown in the first image;
a first display means for displaying the first image in a first region of the image display unit; and
a second display means for displaying the second image in a second region of the image display unit,
wherein the second receiving means receives other partial images from an external device while the second display means displays previously received partial images among a plurality of partial images of the segmented second image.

16. The image displaying apparatus of claim 15, wherein the first receiving means receives other partial images from an external device while the first display means displays previously received partial images among a plurality of partial images of the segmented first image.

17. The image displaying apparatus of claim 15 further comprising:
a first specification reception means for receiving from a user a specification of parts of the first image required for display; and
a transmitting means for transmitting a first part specified information specifying the parts of the first image required for the display to an external device.

18. The image displaying apparatus of claim 17 further comprising:
a second specification reception means for receiving the assignment of parts of the second image required for display from a user; and
a transmitting means for transmitting a second part specified information specifying the parts of the second image required for the display to an external device.

19. The image displaying apparatus of claim 18 further comprising a determining means for determining whether or not partial images specified by the second specification reception means have already been received,
wherein the transmitting means transmits the second part specified information to an external device when the determining means determines that the partial image has not been received.

20. A computer readable recording medium for recording computer programs executed by a computer, wherein the computer program provides the computer with the functionality of:
a first receiving means for receiving a first image showing cells from an external device;
a second receiving means for receiving from an external device a second image of a higher resolution than the first image of the cell shown in the first image;
a first display means for displaying the first image received by the first receiving means in a first region of the image display unit; and
a second display means for displaying part of the second image received by the second receiving means in a second region of the image display unit,
wherein the second receiving means receives other partial images from an external device while the second display means displays previously received partial images among a plurality of partial images of the segmented second image.
